(19) United States
(12) Patent Application Publication
(10) Pub. No.: US 2016/0073107 A1
(43) Pub. Date: Mar. 10, 2016

(54) METHOD AND APPARATUS FOR VIDEO ENCODING/DECODING USING INTRA PREDICTION

(71) Applicant: INTELLECTUAL DISCOVERY CO., LTD., Seoul (KR)

(72) Inventors: Joo Hee MOON, Seoul (KR); Kwang Hyun CHOI, Seoul (KR); Jong Ki HAN, Seoul (KR)

(73) Assignee: INTELLECTUAL DISCOVERY CO., LTD, Seoul (KR)

(21) Appl. No.: 14/784,467

(22) PCT Filed: Apr. 15, 2014
(86) PCT No.: PCT/KR2014/003261

§ 371 Date: Oct. 14, 2015

(30) Foreign Application Priority Data
Apr. 15, 2013 (KR) 10-2013-0041303
Apr. 15, 2013 (KR) 10-2013-0041304

(51) Int. Cl. H04N 19/103; H04N 19/503; H04N 19/176

(52) U.S. Cl. CPC H04N 19/103; H04N 19/176; H04N 19/503

(57) ABSTRACT

The encoding method, according to one embodiment of the present invention, is a video encoding method comprising the steps of: determining an encoding mode of an image block; determining whether a curved-type prediction mode is performed when the encoding mode is an intra prediction; and performing intra encoding according to the whether the curved-shaped prediction has been carried out and the base intra prediction mode.

### BACKGROUND OF THE INVENTION

1. Field of the Invention

The present invention relates to a video codec, and more particularly, to a method and an apparatus for providing a video codec using a curved prediction technology.

2. Discussion of the Related Art

During an intra prediction process of general HEVC, an intra prediction is performed in 34 linear directions. In such a method, there is a limit in encoding efficiency in a part with a curved edge or a region in which brightness gradually varies (like a background sky part in a Kimono sequence) and in this case, there is a problem in that a contour error occurs.

### SUMMARY OF THE INVENTION

An object of the present invention is to provide a method and an apparatus that overcomes a limit in encoding efficiency and a contour error during an intra prediction in a video codec.

However, technical objects which embodiments of the present invention intend to achieve are not limited the aforementioned technical object and other technical objects may be present.

As technical means for achieving the technical object, a video codec providing method according to a first aspect, a curved prediction is performed during an intra prediction and a prediction filter, a filtering method, a pixel interpolation method, an MPM deciding method, a transform method, and a scanning method are decided according to a curved prediction form and mode information.

In accordance with an embodiment of the present invention, a video encoding method includes: determining an encoding mode for a video block; determining whether a curved prediction mode is performed when the encoding mode is an intra prediction; and performing intra encoding according to whether the curved prediction is performed and a base intra prediction mode.

According to embodiments of the present invention, a curved prediction is performed in intra prediction to improve encoding efficiency in a part with a curved edge or a region in which brightness gradually varies (like a background sky part in a Kimono sequence).

In the future, a video signal having a resolution which is still higher than a 4K video which HEVC currently has as an encoding target will be compressed and under such an environment, an advantage of the present patent technology will be shown very efficiently.

### BRIEF DESCRIPTION OF THE DRAWINGS

FIG. 1 is a block diagram illustrating one example of a configuration of a video encoding apparatus;

FIG. 2 is a block diagram illustrating one example of a configuration of a video decoding apparatus;

FIG. 3 is a diagram illustrating one example of intra prediction modes;

FIG. 4 is a diagram for describing a difference between a case in which a curved intra prediction is performed and a case in which a linear intra prediction is considered;

FIG. 5 illustrates an example in which a vertical prediction mode is decided through an intra prediction method used in HEVC;

FIG. 6 illustrates a prediction mode of a first line in a prediction block;

FIG. 7 illustrates the prediction mode of a second line in the prediction block;

FIG. 8 illustrates prediction angles of a third line and a fourth line in the prediction block;

FIG. 9 illustrates prediction angles of the first and second lines when difference_angle is −1;

FIG. 10 illustrates prediction angles of the third and fourth lines when difference_angle is −1;

FIG. 11 illustrates the prediction angle when HEVC base_intra_prediction_mode is mode #18;

FIG. 12 illustrates a position of a pixel of a current PU according to an embodiment of the present invention;

FIGS. 13 and 14 are diagrams for describing positions of pixels predicted when difference_angle=−1;

FIG. 15 illustrates a prediction pixel position adopting difference_angle when base_intra_mode<7;

FIG. 16 illustrates the prediction pixel position adopting difference_angle when 7<=base_intra_mode<14;

FIG. 17 illustrates the prediction pixel position adopting difference_angle when 14<=base_intra_mode<23;

FIG. 18 illustrates the prediction pixel position adopting difference_angle when 23<=base_intra_mode<30;

FIG. 19 illustrates the prediction pixel position adopting difference_angle when 30<=base_intra_mode<35;

FIGS. 20 to 25 illustrate forms of indexes to be encoded when a prediction mode is encoded;

FIG. 26 illustrates a flowchart of a method for performing a curved intra prediction according to an embodiment of the present invention stepwise;

FIG. 27 illustrates a first reference pixel and a second reference pixel for calculating difference_intra_prediction_mode;

FIG. 28 illustrates the prediction mode of the second line in the prediction block;

FIG. 29 illustrates prediction angles of a third line and a fourth line in a prediction block according to another embodiment of the present invention;

FIGS. 30 and 31 illustrate a case in which difference_intra_prediction_mode=−1;

FIGS. 32 and 33 illustrate the case in which difference_intra_prediction_mode=−1;

FIG. 34 illustrates a prediction pixel position adopting difference_intra_prediction_mode when base_intra_mode<7;

FIG. 35 illustrates the prediction pixel position adopting difference_intra_prediction_mode when 7<=base_intra_mode<14;

FIG. 36 illustrates the prediction pixel position adopting difference_intra_prediction_mode when 14<=base_intra_mode<23;

FIG. 37 illustrates the prediction pixel position adopting difference_intra_prediction_mode when 23<=base_intra_mode<30;

FIG. 38 illustrates the prediction pixel position adopting difference_intra_prediction_mode when 30<=base_intra_mode<35;

FIG. 39 illustrates a flowchart of a curved intra prediction;

FIGS. 40 to 45 illustrate syntax information regarding a curved intra prediction mode to be encoded when the curved intra prediction mode is encoded according to an embodiment of the present invention; and

FIG. 46 illustrates a flowchart of decoding the curved intra prediction.

### DETAILED DESCRIPTION OF THE EMBODIMENTS

Hereinafter, embodiments of the present invention will be described so as to be easily implemented by those skilled in the art, with reference to the accompanying drawings. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout this specification and the claims that follow, when it is described that an element is “coupled” to another element, the element may be “directly coupled” to the other element or “electrically coupled” to the other element through a third element.

Throughout this specification, when it is described that a member is positioned on another member, the member may “contact” the other member or a third member may be interposed between both members.

In the specification, unless explicitly described to the contrary, the word “comprise” and variations such as “comprises” or “comprising”, will be understood to imply the inclusion of stated elements but not the exclusion of any other elements. “Approximately”, “substantially”, and the like which are terms of a degree used throughout the specification of the present invention are used, when unique manufacturing and material tolerances are presented as mentioned meanings, as “in the numerical value” or “close to the numerical value” and are used to prevent disclosed contents in which accurate or absolute numerical values are mentioned in order to assist understanding the present invention from being wrongly used by an unscrupulous pirate. “Step (which)” or “step of” which is a term of a degree used throughout the specification of the present invention does not mean “step for”.

Throughout the specification of the present invention, a term of a combination of elements included in a Markush form expression means one or more mixtures or combinations selected from a group consisting of components disclosed in the Markush form expression and means including one or more selected from the group consisting of the components.

As an example of encoding the actual image and the depth information map thereof, encoding may be performed by using high efficiency video coding (HEVC) which is jointly standardized in MPEG (Moving Picture Experts Group) and VCEG (Video Coding Experts Group) having highest encoding efficiency among video encoding standards developed up to now.

According to the embodiment of the present invention, a curved prediction is performed during an intra prediction.

A video codec technology according to an embodiment of the present invention proposes prediction filters for each curve form and mode.

The video codec technology according to the embodiment of the present invention proposes a filtering method of contiguous pixels (similar intra smoothing of current HEVC) according to a curved prediction form and a curved prediction mode.

The video codec technology according to the embodiment of the present invention proposes a method that interpolates the contiguous pixels in order to adopt a curved prediction filter.

The video codec technology according to the embodiment of the present invention proposes a method that encodes curve form and mode information. In this case, an MPM deciding method according to the curved prediction form and mode is proposed.

The video codec technology according to the embodiment of the present invention use different transforms according to the curve form and mode information.

The video codec technology according to the embodiment of the present invention use different transform coefficient scanning methods according to the curve form and mode information.

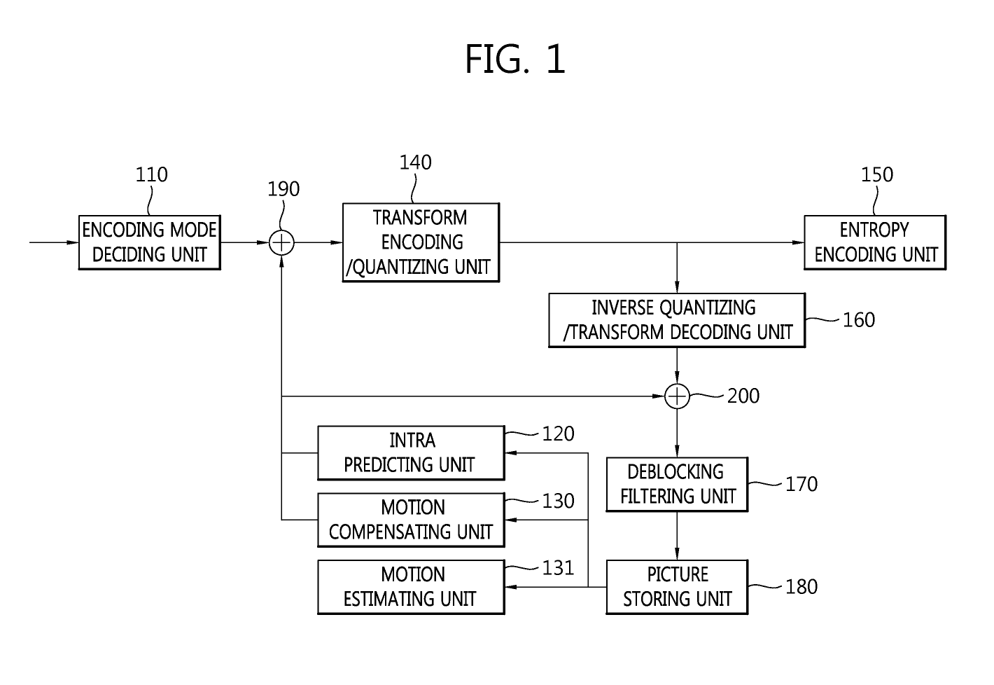

FIG. 1 is a block diagram illustrating one example of a configuration of a video encoding apparatus and the illustrated encoding apparatus includes an encoding mode deciding unit 110, an intra predicting unit 120, a motion compensating unit 130, a motion estimating unit 131, a transform encoding/quantizing unit 140, an entropy encoding unit 150, an inverse quantizing/transform decoding unit 160, a deblocking filtering unit 170, a picture storing unit 180 a subtracting unit 190, and an adding unit 200.

Referring to FIG. 1, the encoding mode deciding unit 110 analyzes an input vide signal to segment a picture into encoding blocks having a predetermined size and decide an encoding mode for the segmented encoding blocks having the predetermined size. The encoding mode includes intra prediction encoding and inter prediction encoding.

The picture is constituted by multiple slices and the slice is constituted by multiple largest coding units (LCUs). The LCU may be segmented into multiple coding units (CUs) and an encoder may add information (flag) indicating the segmentation or not to a bitstream. The decoder may recognize the position of the LCU by using an address LcuAddr. A coding unit (CU) when the segmentation is not permitted may be regarded as a prediction unit (PU) and the decoder may recognize the position of the PU as a PU index.

The prediction unit (PU) may be divided into multiple partitions. Further, the prediction unit (PU0 may be constituted by multiple transform units (TUs).

The encoding mode deciding unit 110 transmits video data to the subtracting unit 190 by the unit (for example, a PU unit or a TU unit) of the blocks having the predetermined size according to the decided encoding mode.

The transform encoding/quantizing unit 140 transforms a residue block calculated by the subtracting unit 190 into a frequency domain from a space domain.

For example, the residue block is transformed based on 2D discrete cosine transform (DCT) or discrete sine transform (DST). Further, the transform encoding/quantizing unit 140 decides a quantization step size for quantizing a transform coefficient and quantizes the transform coefficient by using the decided quantization step size. A quantization matrix may be decided according to the decided quantization step size and the encoding mode.

The quantized 2D transform coefficient is transformed into a 1D quantization transform coefficient by one of predetermined scanning methods.

A sequence of the transformed 1D quantization transform coefficients is provided to the entropy encoding unit 150.

The inverse quantizing/transform decoding unit 160 inversely quantizes a quantization coefficient quantized by the transform encoding/quantizing unit 140. Further, an inverse quantization coefficient acquired by the inverse quantization is inversely transformed. As a result, the residue block transformed into the frequency domain may be recovered into the residue block of the space domain.

The deblocking filtering unit 170 receives video data inversely quantized and inversely transformed from the inverse quantizing/transform encoding unit 160 to perform filtering for removing a blocking effect.

The picture storing unit 180 receives the filtered video data from the deblocking filtering unit 170 to recover and store a video by the unit of the picture. The picture may be a frame unit video or a field unit video.

The picture storing unit 180 includes a buffer (not illustrated) that may store multiple pictures. The multiple pictures stored in the buffer are provided for an intra prediction and a motion estimation. The pictures provided for the intra prediction or the motion estimation are called reference pictures.

The motion estimating unit 131 performs the motion estimation by receiving at least reference picture stored in the picture storing unit 180 to output motion data an index and a block mode representing the reference picture.

In order to optimize prediction precision, a motion vector is decided with decimal pixel precision, for example, ½ or ¼ pixel precision. Since the motion vector may have the decimal pixel precision, the motion compensating unit 130 applies an interpolation filter for calculating a pixel value a decimal pixel position to the reference picture to calculate the pixel value of the decimal pixel position from a pixel value of an integer pixel position.

The motion compensating unit 130 extracts and outputs a prediction block corresponding to a block to be encoded from the reference picture used for the motion estimation among the multiple reference pictures stored in the picture storing unit 180 according to the motion data input from the motion estimating unit 131.

The motion compensating unit 130 decides a filter feature of an adaptive interpolation filter required for the motion compensation of decimal precision. The filter feature may include, for example, information indicting a filter type the adaptive interpolation filter and information indicating the size of the adaptive interpolation filter. The size of the filter is, for example, a tap number which is the number of the filter coefficients of the adaptive interpolation filter.

In detail, the motion compensating unit 130 as the adaptive interpolation filter may decide any one of separation type and non-separation type adaptive filters. Then, the decided tap number of the adaptive interpolation filter and a value of each filter coefficient are decided. The value of the filter coefficient may be decided differently for each relative position of the decimal pixel to the integer pixel. Further, the motion compensating unit 130 may use multiple non-adaptive interpolation filters in which the filter coefficient is fixed.

The motion compensation unit 130 may configure the feature of the interpolation filter by the predetermined processing unit. For example, the feature may be configured by the decimal pixel unit, the coding basic unit (coding unit), the slice unit, the picture unit, or the sequence unit. Further, one feature may be configured with respect to one video datum. Therefore, within the predetermined processing unit, since the same filter feature is used, the motion compensating unit 130 includes a memory temporarily storing the filter feature. The memory stores the filter feature and the filter coefficient as necessary. For example, the motion compensating unit 130 may decide the filter feature every I picture and decide the filter coefficient by the slice unit.

The motion compensating unit 130 receives the reference picture from the picture storing unit 180 and applies filter processing by using the decided adaptive interpolation filter to generate a prediction reference image with the decimal precision.

In addition, the motion compensation with the decimal pixel precision is performed based on the motion vector decided by the motion estimating unit 131 to generate the prediction block.

When an input block to be encoded is subjected to inter-picture prediction encoding, the subtracting unit 190 performs differential calculation with an input macro block by receiving the block in the reference picture, which corresponds to the input block from the motion compensating unit 130 to output a residue signal.

The intra predicting unit 120 performs the intra prediction encoding by using a reconfigured pixel value in the picture in which the prediction is performed. The intra predicting unit selects one of multiple predetermined intra prediction modes according to the size of a current block by receiving the current block to be prediction-encoded to perform the intra prediction. The intra predicting unit 120 decides the intra prediction mode of the current block by using previously encoded pixels adjacent to the current block and generates the prediction block corresponding to the decided mode.

A previously encoded region among regions included in a current picture is decoded again to be used by the intra predicting unit 120 again, and as a result the encoded area is stored in the picture storing unit 180. The intra predicting unit 120 generates the prediction block of the current block by using a pixel adjacent to the current block or pixels which are not adjacent to the current block, but are applicable in the previously encoded region of the current picture, which is stored in the picture storing unit 180.

The intra predicting unit 120 may adaptively filter the adjacent pixel in order to predict the intra block. Information for notifying filtering or not in the encoder may be transmitted for the same motion in the decoder. Alternatively, the filtering or not may be decided based on the intra prediction mode of the current block and the size information of the current block.

A prediction type used by the video encoding apparatus depends on whether the input block is encoded in the intra mode or the inter mode by the encoding mode deciding unit.

Switching the intra mode and the inter mode is controlled by an intra/inter switch.

The entropy encoding unit 150 entropy-encodes the quantization coefficient quantized by the transform encoding/quantizing unit 140 and the motion information generated by the motion estimating unit 131. Further, the intra prediction mode, control data (for example, the quantization step size, and the like), and the like may be encoded. In addition, the filter coefficient decided by the motion compensating unit 130 is also encoded and output as the bitstream.

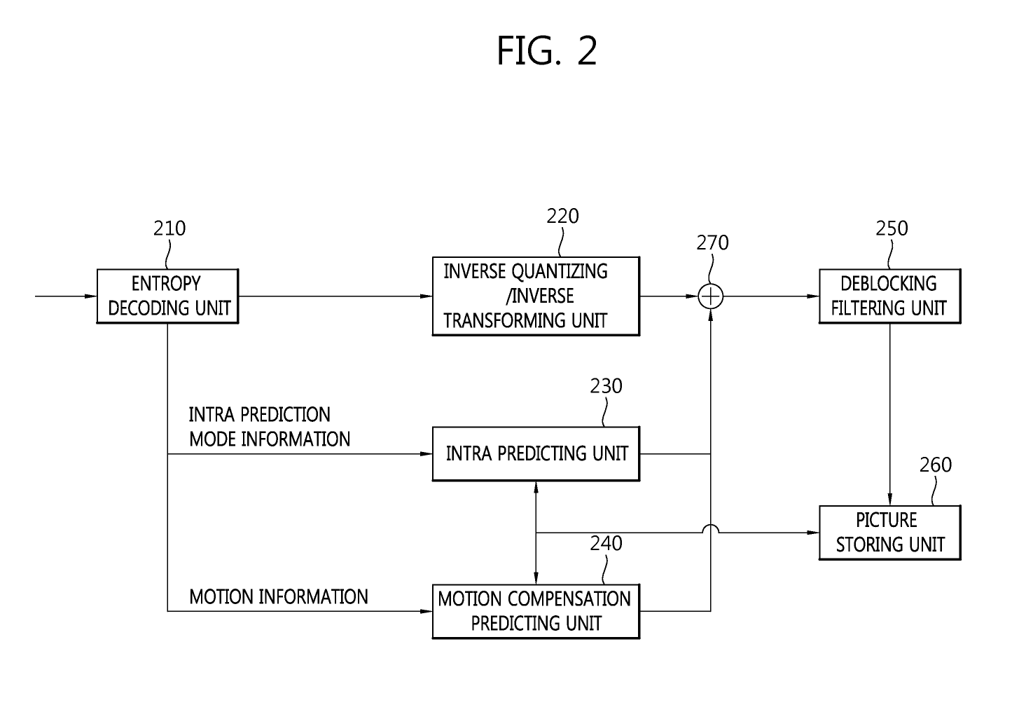

FIG. 2 is a block diagram illustrating one example of a configuration of a video decoding apparatus and the illustrated decoding apparatus includes a decoding unit 210, an inverse quantizing/inverse transforming unit 220, an adder 270, a deblocking filtering unit 250, a picture storing unit 260, an intra predicting unit 230, a motion compensation predicting unit 240, and an intra/inter switch 280.

Referring to FIG. 2, the entropy decoding unit 210 decodes an encoding bitstream transmitted from a moving picture encoding apparatus to separate the decoded encoding bitstream into an intra prediction mode index, motion information, a quantization coefficient sequence, and the like. The entropy decoding unit 210 provides the decoded motion information to the motion compensation predicting unit 240. The entropy decoding unit 210 provides the intra prediction mode index to the intra predicting unit 230 and the inverse quantizing/inverse transforming unit 220. In addition, the entropy decoding unit 210 provides the inverse quantization coefficient sequence to the inverse quantizing/inverse transforming unit 220.

The inverse quantizing/inverse transforming unit 220 transforms the quantization coefficient sequence to an inverse quantization coefficient of a 2D array. One among multiple scanning patterns is selected for the transform. One among the multiple scanning patterns is selected based on the prediction mode (that is, any one of the intra prediction and the inter prediction) of the current block, the intra prediction mode, and the size of the transform block.

The intra prediction mode is received from the intra predicting unit or the entropy decoding unit 210.

The inverse quantizing/inverse transforming unit 220 recovers the quantization coefficient by using the inverse quantization coefficient of the 2D array and a quantization matrix selected among multiple quantization matrices. The quantization matrix may be decided by using information received from the encoder.

Different quantization matrices may be applied according to the size of the current block (transform block) to be recovered and the quantization matrix may be selected based on at least one of the prediction mode and the intra prediction mode of the current block even with respect to the block having the same size. In addition, the recovered quantization coefficient is inversely transformed to recover the residue block.

The adder 270 adds the residue block recovered by the inverse quantizing/inverse transforming unit 220 and the prediction block generated by the intra predicting unit 230 or the motion compensation predicting unit 240 to recover a video block.

The deblocking filter unit 250 performs deblocking filter processing of the recovery video generated by the adder 270. As a result, a deblocking artifact caused by a video loss depending on a quantization process may be reduced.

The picture storing unit 260 is a frame memory storing a local decoding video which is subjected to the deblocking filter processing by the deblocking filter unit 250.

The intra predicting unit 230 recovers the intra prediction mode of the current block based on the intra prediction mode index received from the entropy decoding unit 210. In addition, the prediction block is generated according to the recovered intra prediction mode.

The motion compensation predicting unit 240 generates the prediction block for the current block from the picture stored in the picture storing unit 260 based on the motion vector information. When the motion compensation with the decimal precision is applied, the selected interpolation filter is applied to generate the prediction block.

The intra/inter switch 280 provides to the adder 270 the prediction block generated in any one of the intra predicting unit 230 and the motion compensation predicting unit 260 based on the encoding mode.

In video codec technologies standardized up to now, pixel values in one picture are encoded by the unit of the block. When pixels values of the block to be currently encoded are similar to contiguous blocks in the same video, the intra encoding may be performed by using the similarity.

Meanwhile, when a current coding block is an intra coded block, the current block is predicted by referring to pixels values of already encoded contiguous blocks to predict the current block and thereafter, encode a prediction residue signal. Spatial prediction encoding is performed by using 35 prediction modes in HEVC.

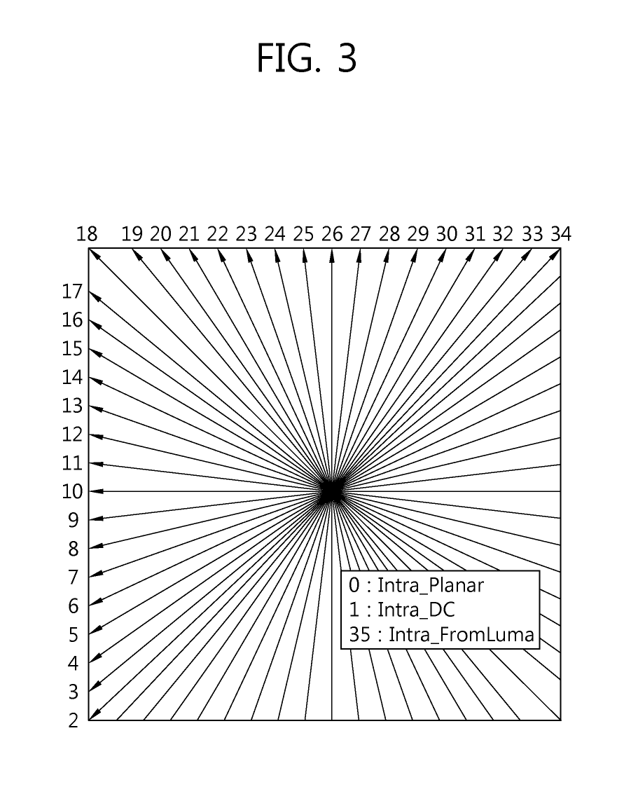

FIG. 3 is a diagram illustrating one example of intra prediction modes and illustrates prediction modes and a prediction direction of the intra prediction considered in the HEVC.

Referring to FIG. 3, the number of intra prediction modes may depend on the size of the block. For example, when the size of the current block is 8×8, 16×16, and 32×32, 34 intra prediction modes may be present and when the size of the current block is 4×4, 17 intra prediction modes may be present. The 34 or 17 intra prediction modes may be constituted by at least one non-directional mode and multiple directional modes.

At least one non-directional mode may be a DC mode and/or a planar mode. When the DC mode and the planar mode are included in the non-directional mode, 35 intra prediction modes may be present regardless of the size of the current block. In this case, 2 non-directional modes (DC mode and planar mode) and 33 directional modes may be included.

The planar mode generates the prediction block of the current block b using at least one pixel value (alternatively, a prediction value of the pixel value, hereinafter, referred to as a first reference value) positioned at a bottom-right side of the current block and the reference pixels.

In the linear intra prediction mode illustrated in FIG. 3, there is a limit in encoding efficiency in a part with a curved edge or a region in which brightness gradually varies (like a background sky part in a Kimono sequence). In this case, a contour error may occur.

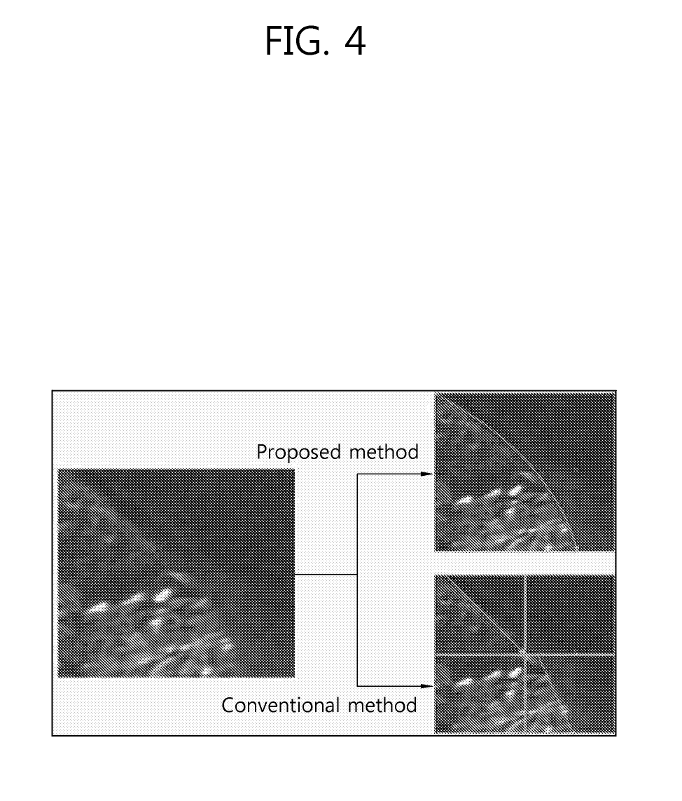

FIG. 4 is a diagram for describing a difference between a case in which a curved intra prediction is performed and a case in which a linear intra prediction is considered.

In a general compression standard, intra encoding is performed by considering only various linear prediction directions. As the size of the video increases, the intra prediction having various prediction block sizes and various directions is performed, but the prediction is performed by still considering only the linear direction, and as a result, an intra prediction technique considering curved data of the video is not used.

Referring to FIG. 4, an edge of the video in FIG. 4 is present with a curve shape in a diagonal direction. If the existing general intra prediction encoding is performed, the block is segmented and the respective blocks are encoded by linear intra predictions in different modes. When the video of FIG. 4 is encoded by the existing method, prediction accuracy also decreases and the block is segmented and encoded, and as a result, a lot of header bits are generated.

Therefore, according to the embodiment of the present invention, when the intra prediction is performed by the curved intra prediction method, the block may be encoded in one intra prediction mode while the blocking is not segmented and the prediction accuracy may also be high.

In the present invention, the linear intra prediction and the curved intra prediction may be performed by using various prediction modes according to a feature of video information to be encoded.

Explicit Curved Intra Prediction

According to the embodiment of the present invention, a curved prediction may be explicitly performed during the intra prediction.

In the exemplary embodiment of the present invention, in order to perform the curved intra prediction, (1) a process of deciding base_intra_prediction_mode and (2) a process of deciding line_intra_prediction_mode for each prediction line may be executed.

In the present specification, a line may be a set of pixels that are present on the same horizontal line or a set of pixels that are present on the same vertical column. Alternatively, the line may be a set of pixels having the same angle in the diagonal direction.

First, a base direction (base_intra_prediction_mode) to intra-predict the current prediction block is decided and thereafter, next, a prediction direction mode (line_intra_prediction_mode) adjusted for each line is decided.

(1) Deciding base_intra_prediction_mode

This step may include a step of deciding the base prediction direction used when performing the curved intra prediction of the current prediction block. The base prediction direction mode (base_intra_prediction_mode) is decided by using the intra prediction mode deciding method performed in the exiting HEVC. That is, when the current encoding block is intra-predicted by using contiguous pixel values of the current encoding block, the existing HEVC intra predicting method considering a total of 35 prediction modes is used. As such, base_intra_prediction_mode is decided by the existing intra prediction method of the HEVC and thereafter, in next step, the curved intra prediction similar thereto is performed.

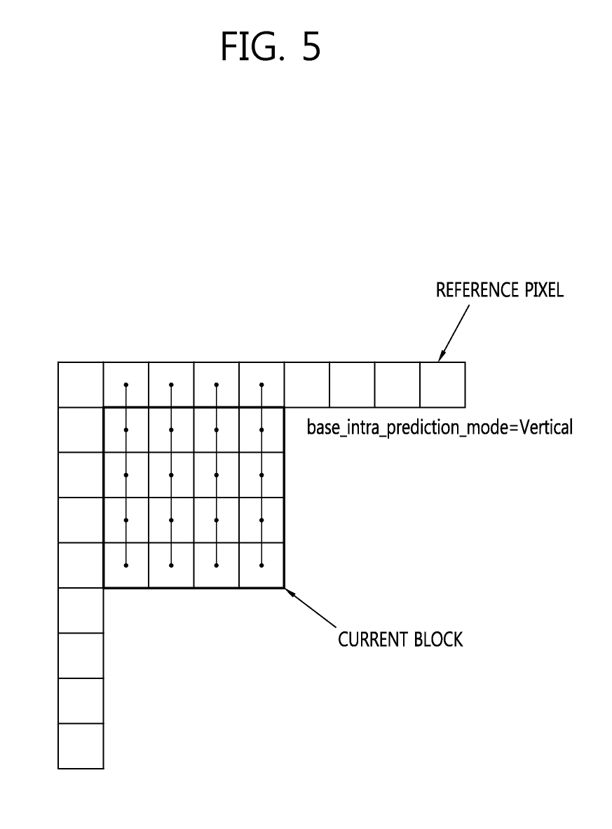

FIG. 5 illustrates an example in which a vertical prediction mode is decided through an intra prediction method used in HEVC. In this example, in order to encode the current prediction block, 35 prediction modes used by the HEVC are considered and finally, it is described that the vertical prediction mode is selected as an example. The vertical mode decided in this example may be called base_intra_prediction_mode in the present invention.

(2) Deciding line_intra_prediction_mode

A case in which base_intra_prediction_mode is a vertical mode will be described as an example. In this case, since base_intra_prediction_mode is the vertical mode, the line becomes a set of pixels at the same horizontal position. In this case, the respective lines are similar to the vertical mode, but are intra-predicted in slightly different directions.

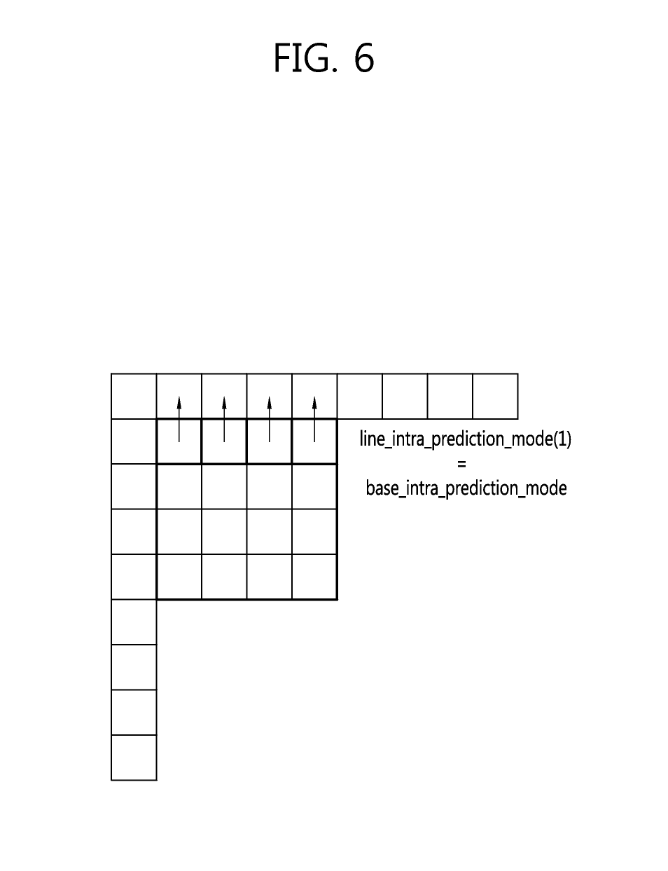

FIG. 6 illustrates a prediction mode of a first line in a prediction block.

As illustrated in FIG. 6, a first FIG. 6 in the prediction block may show a prediction angle of a first line of the 4×4 PU. line_intra_prediction_mode(1) of the first line becomes a mode which is the same as base_intra_prediction_mode.

From a second line, the prediction may be performed at an angle which deviates from the vertical mode which is base_intra_prediction_mode by the left (−1) or the right (+1).

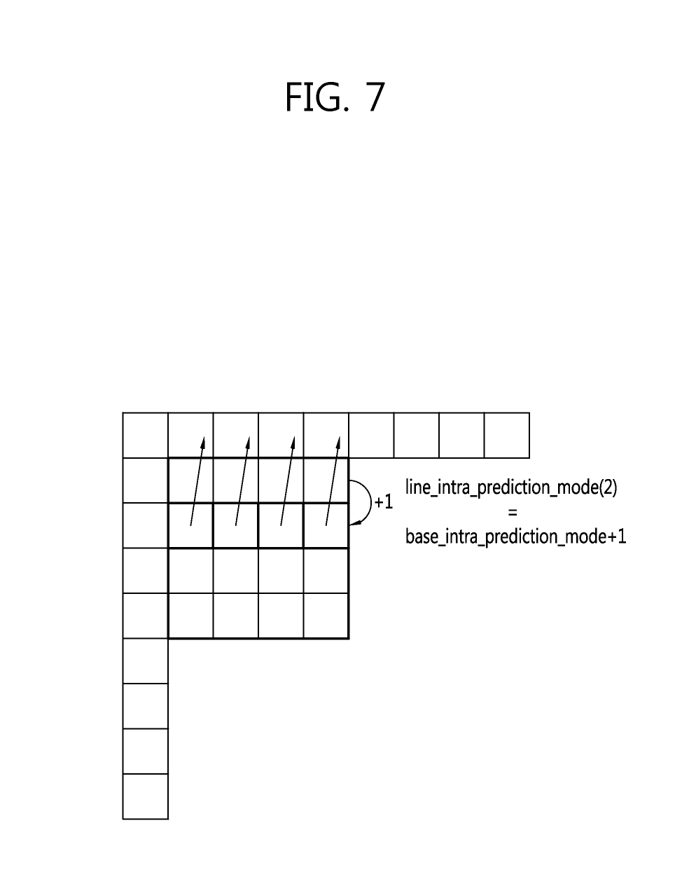

FIG. 7 illustrates the prediction mode of the second line in the prediction block.

As illustrated in FIG. 7, line_intra_prediction_mode(2) which is the prediction angle of the second line may be shown. In FIG. 7, a case of line_intra_prediction_mode(2)=base_intra_prediction_mode+1 which deviates by the right is shown. In some cases, In FIG. 7, line_intra_prediction_mode(2)=base_intra_prediction_mode−1 which deviates by the left may be used. As the line gradually decreases, the angle gradually decreases.

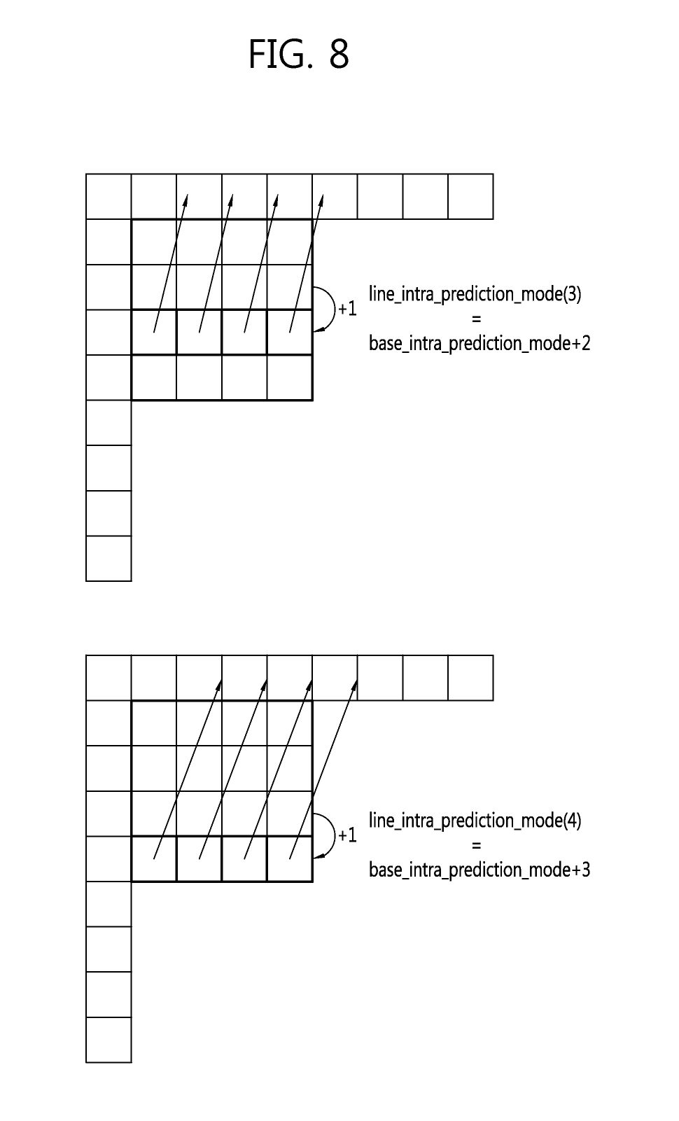

FIG. 8 illustrates prediction angles of a third line and a fourth line in the prediction block.

As illustrated in FIG. 8, the third line is predicted at an angle of base_intra_prediction_mode+2 and the fourth line is predicted at an angle of base_intra_prediction_mode+3.

In the embodiment of the present invention, a difference in prediction direction between the line and the line may be defined as difference_angle. difference_angle is limited to −2, −1, 1, and 2 based on base_intra_prediction_mode. That is, a value of difference_angle may have one value of −2, −1, 1, and 2.

A method that selects an optimal difference_angle value of a total of difference_angle values selects a most advantageous value in terms of rate distortion. In detail, in the current prediction block,

the first line is predicted by base_intra_prediction_mode,

the second line is predicted by base_intra_prediction_mode+difference_angle,

the third line is predicted by base_intra_prediction_mode+2*difference_angle, and

the fourth line is predicted by base_intra_prediction_mode+3*difference_angle.

Contents described in FIGS. 5 to 8 may be an example in a case in which difference_angle=1.

In the embodiment of the present invention, during the intra prediction every encoding block, the curved prediction is performed by difference_angle={−2, −1, 1, 2} and thereafter, difference_angle which brings about smallest rate distortion cost is decided among the encoding results.

As such, the curved intra prediction using the optimal difference_angle value is performed every encoding block and thereafter, RD cost in this case and RD cost in a case in which all pixels of the current blocks are predicted in the mode decided in the intra prediction method of the HEVC are compared and thereafter, a mode having the small RD cost is finally selected.

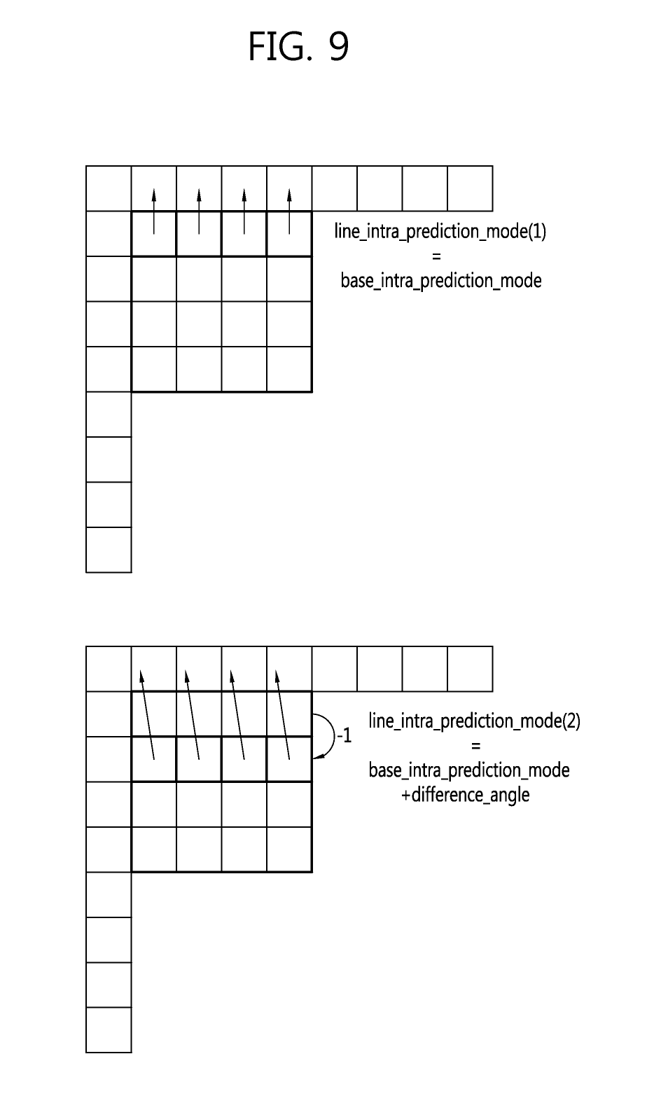

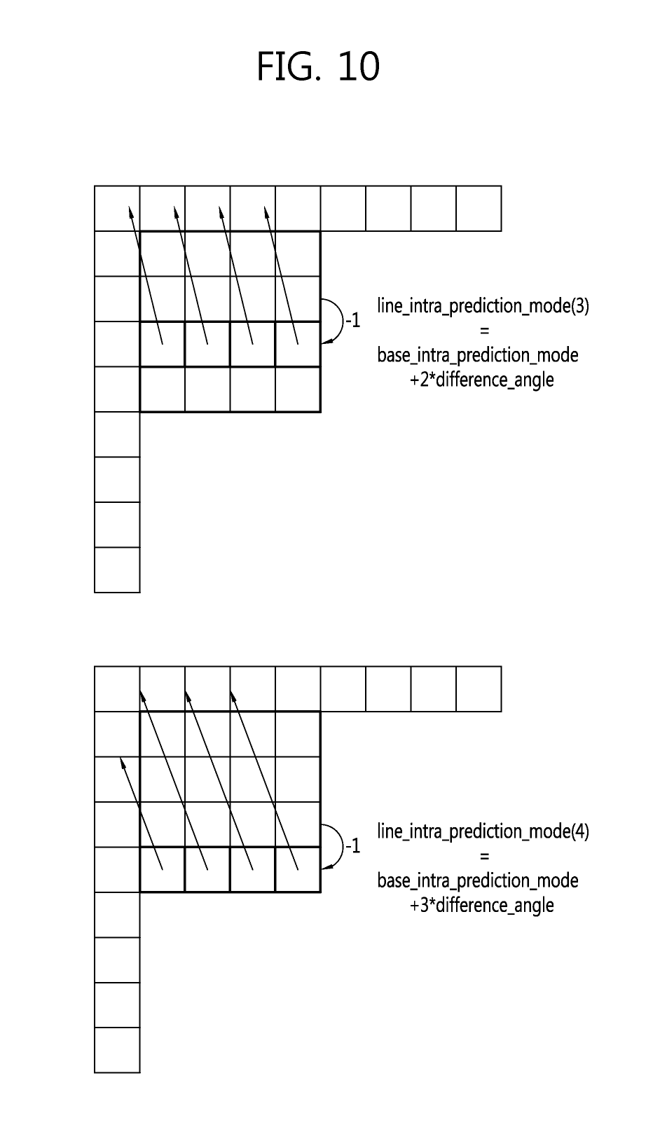

FIG. 9 illustrates prediction angles of the first and second lines when difference_angle is −1. FIG. 10 illustrates prediction angles of the third and fourth lines when difference_angle is −1;

As illustrated in FIGS. 9 and 10, when base_intra_prediction_mode is the vertical mode, the line decreases, the prediction is performed at different prediction angles according to difference_angle. The prediction is performed in a similar method even when difference_angle is +2 and −2 as well as when difference_angle is +1 and −1 given as an example above.

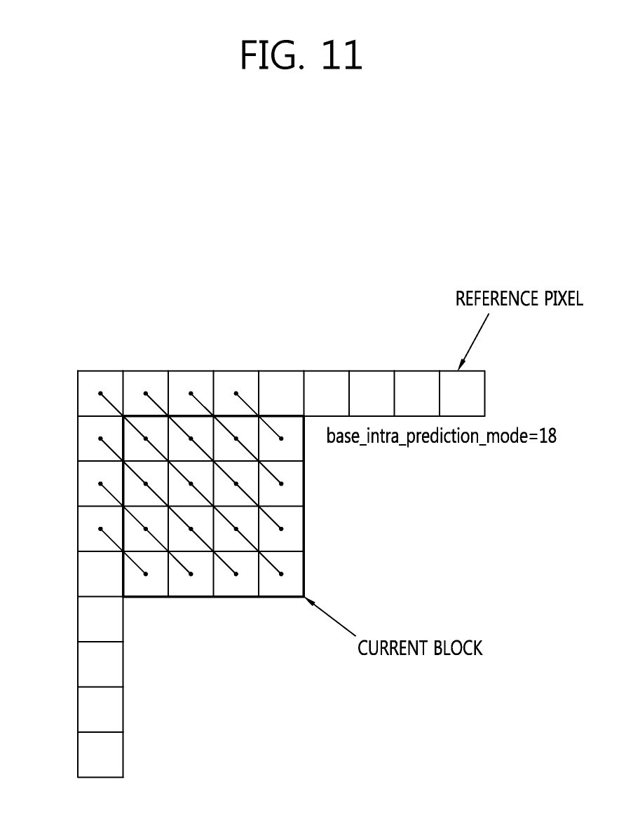

FIG. 11 illustrates the prediction angle when HEVC base_intra_prediction_mode is mode #18.

FIG. 11 is a diagram showing an angle of 135° at which base_intra_prediction_mode is mode #18. The mode #18 is a result decided by applying the existing HEVC intra prediction method to the contiguous pixels.

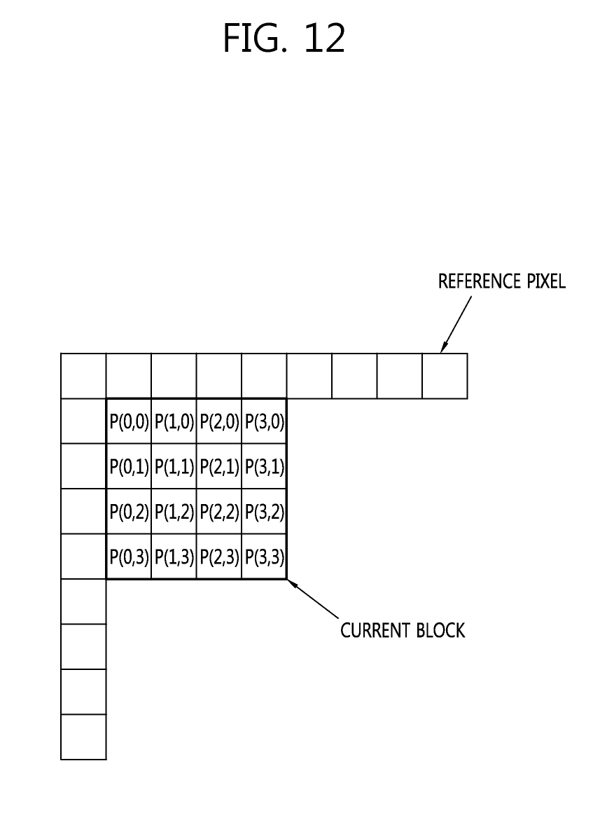

Even in the case illustrated in FIG. 11, difference_angle becomes −2, −1, 1, and 2 and the curved intra prediction is performed with respect to respective difference_angle values. In the next example, the case in which difference_angle is −1 will be described. For easy description, the pixel position of the PU is expressed by a symbol in FIG. 12.

FIG. 12 illustrates a position of a pixel of a current PU according to an embodiment of the present invention.

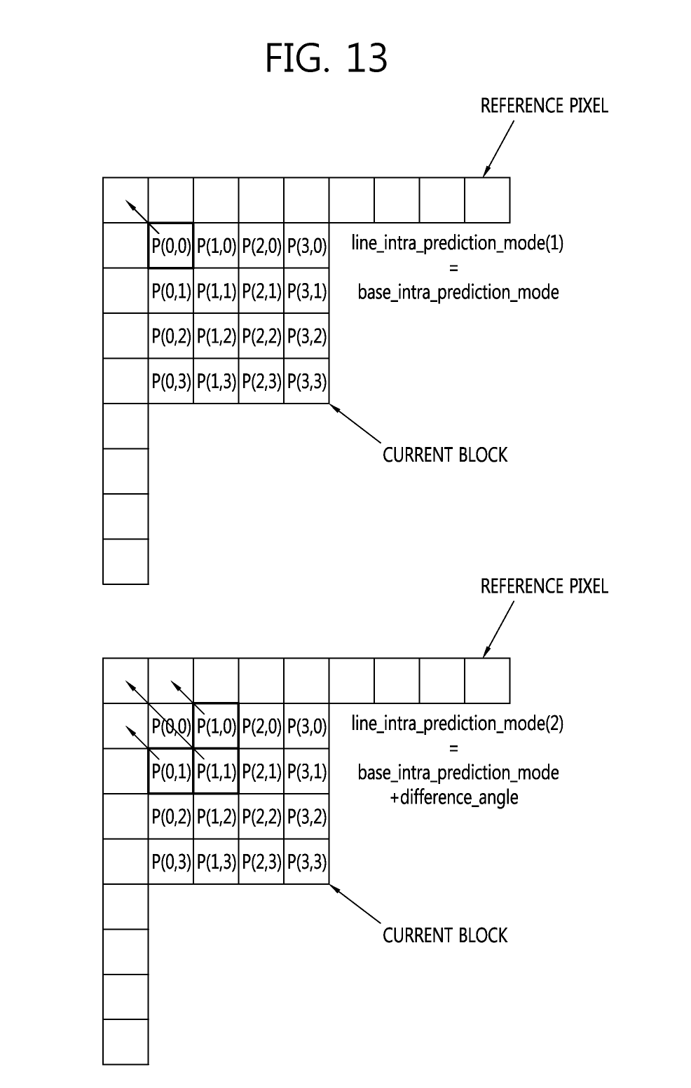

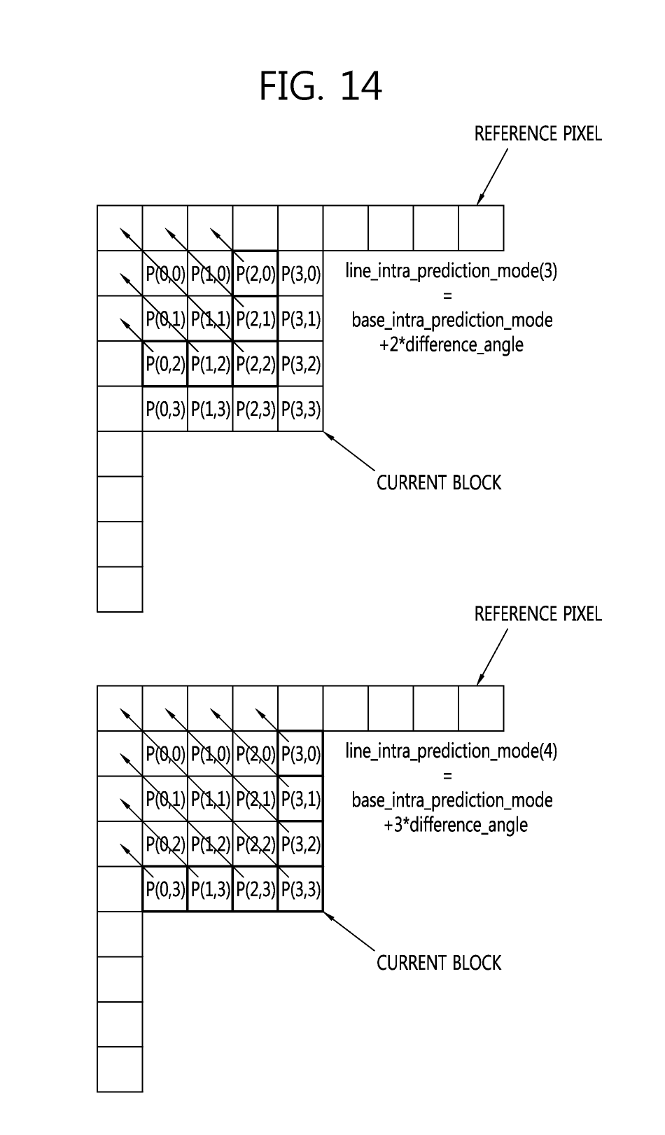

As illustrated in FIG. 11, when base_intra_prediction_mode is mode #18, the line is defined in a form different from that when base_intra_prediction_mode is the vertical mode. When base_intra_prediction_mode is the vertical mode, the line is configured by the unit of the line positioned in the horizontal direction. By comparison, when base_intra_prediction_mode is mode #18, the line is defined as illustrated in FIGS. 13 and 14. First, P(0, 0) becomes the first line. In addition, pixels P(1,0), P(0,1), and P(1,1) become the second line. In such a manner, the definition of the line varies depending on base_intra_prediction_mode.

In FIG. 12, the pixel P(0, 0) that belongs to the first line is predicted as the prediction angle of base_intra_prediction_mode.

The pixels P(1,0), P(0,1), and P(1,1) that belong to the second line is predicted by base_intra_prediction_mode+difference_angle.

Pixels P(2,0), P(2,1), P(2,2), P(0,2), and P(1,2) that belong to the third line is predicted by base_intra_prediction_mode+2*difference_angle.

Pixels P(3,0), P(3,1), P(3,2), P(3,3), P(0,3), P(1,3), and P(2,3) that belong to the fourth line is predicted by base_intra_prediction_mode+3*difference_angle.

Meanwhile, FIGS. 13 and 14 are diagrams for describing positions of pixels predicted when difference_angle=−1.

FIG. 13 illustrates the position of the pixel predicted by base_intra_prediction_mode and the position of the pixel predicted by base_intra_prediction_mode+difference_angle.

FIG. 14 illustrates the position of the pixel predicted by base_intra_prediction_mode+2*difference_angle and the position of the pixel predicted by base_intra_prediction_mode+3*difference_angle.

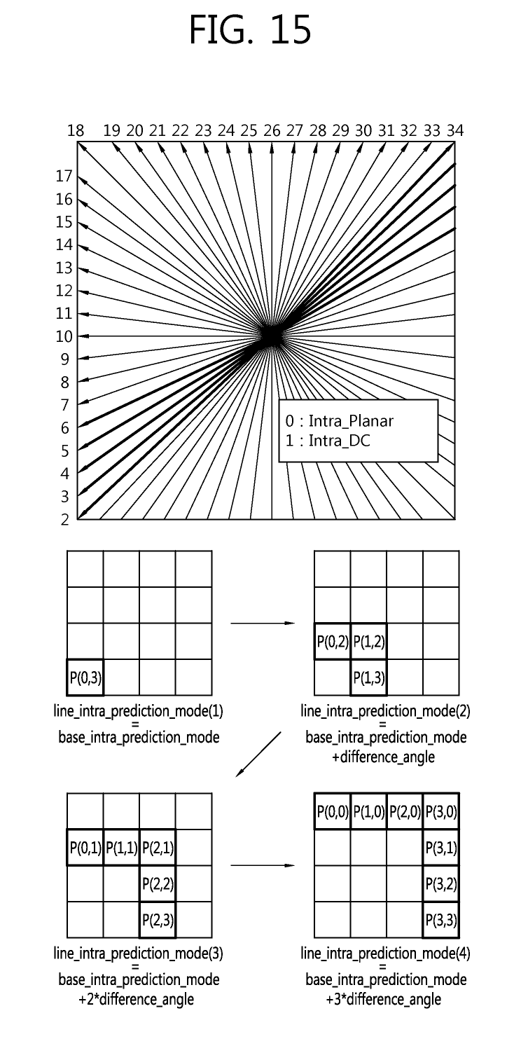

FIG. 15 illustrates a prediction pixel position adopting difference_angle when base_intra_mode<7. FIG. 15 illustrates shapes of lines differentially using difference_angle when base_intra_prediction_mode is smaller than mode #7.

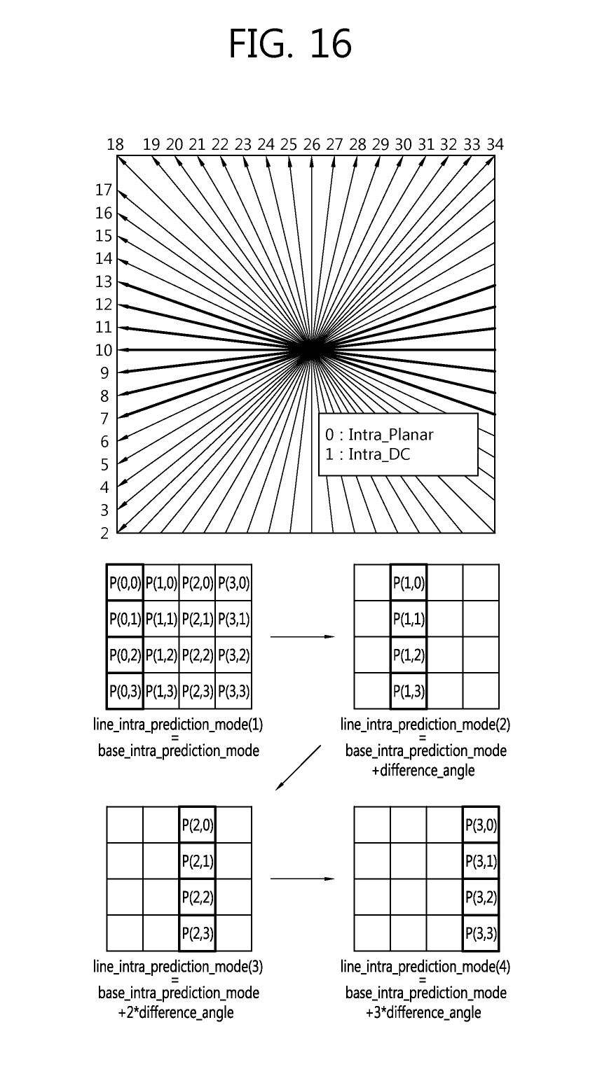

FIG. 16 illustrates the prediction pixel position adopting difference_angle when 7<=base_intra_mode<14. When base_intra_prediction_mode is equal to or larger than 7 or smaller than #14, a shape of a line to which difference_angle is differentially applied may be described.

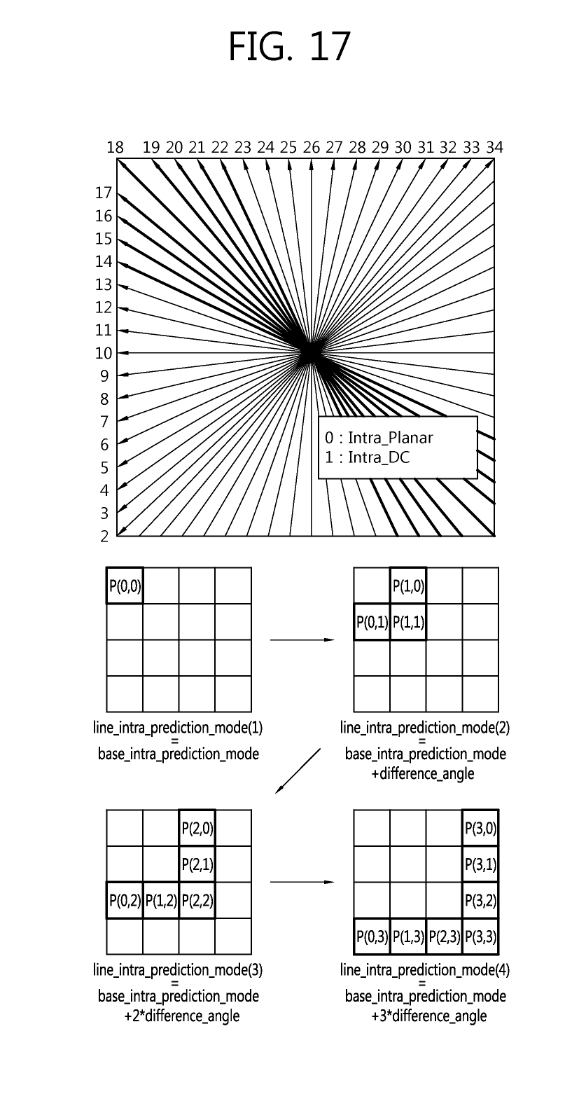

FIG. 17 illustrates the prediction pixel position adopting difference_angle when 14<=base_intra_mode<23. When base_intra_prediction_mode is in 14<=base_intra_prediction_mode<23, a concept of the line to which differential difference_angle is applied is described.

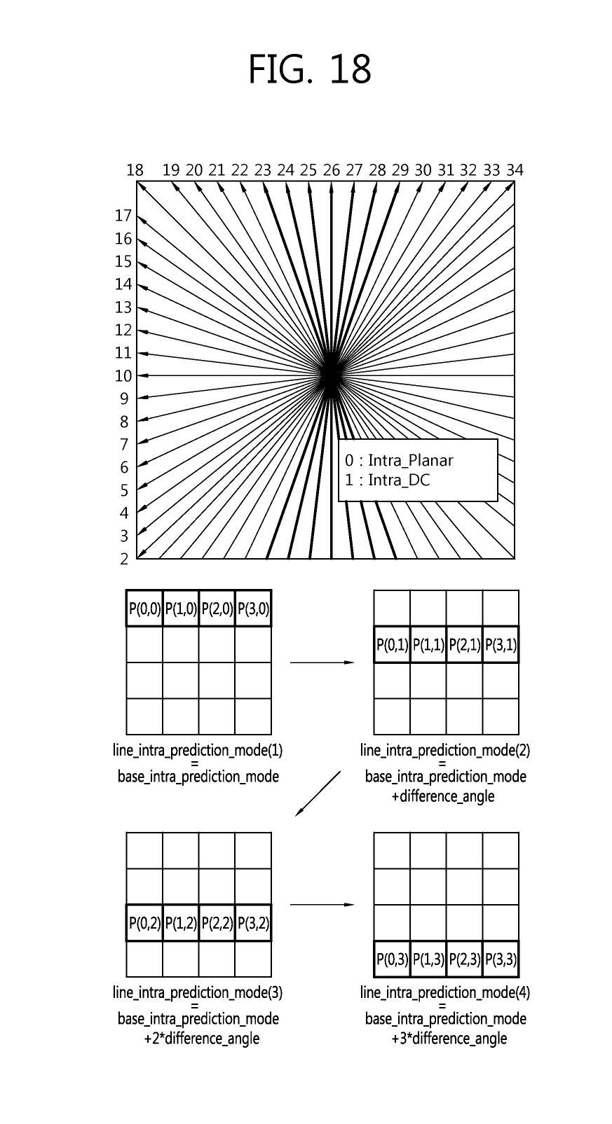

FIG. 18 illustrates the prediction pixel position adopting difference_angle when 23<=base_intra_mode<30. When 23<=base_intra_prediction_mode<30, positions (line shape) of prediction pixels to which difference_angle is differentially applied are shown.

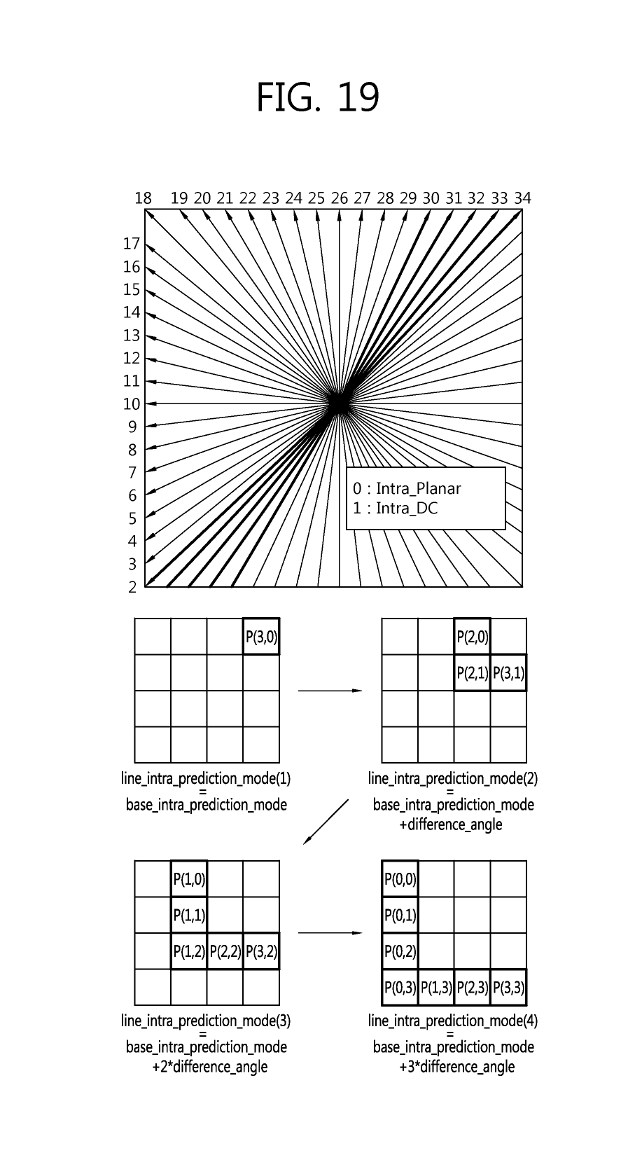

FIG. 19 illustrates the prediction pixel position adopting difference_angle when 30<=base_intra_mode<35. When 30<=base_intra_prediction_mode<35, positions (line shape) of prediction pixels to which difference_angle is differentially applied are shown.

Meanwhile, a mode in which generated cost is smallest among RDcost of base_intra_prediction_mode which is the existing intra prediction optimal mode of the HEVC and a total of four RDcost of base_intra_prediction_mode based curved intra prediction encoding (depending on four difference_angle values) is selected as the optimal mode.

When base_intra_prediction_mode is the DC or planar mode, the curved intra prediction is not performed.

When the optimal mode is the curved intra prediction, the decided mode information is encoded and transmitted as described below. When the optimal mode is the curved intra prediction, curvature_angular_pred becomes 1 and an index of optimal difference_angle is encoded and transmitted. Table 1 is a code book for encoding the index of difference_angle. When the curved intra prediction is not selected, curvature_angular_pred is encoded to 0 to be transmitted.

TABLE 1

| difference_angle | difference_angle index | Binarization |
|---|---|---|
| −2 | 0 | 00 |
| −1 | 1 | 01 |
| 1 | 2 | 10 |
| 2 | 3 | 11 |

When the optimal mode of the current block is encoded, a curved intra prediction flag and a curved intra prediction index are added to the existing optimal mode encoding method. curvature_angular_pred for notifying execution of the curved intra prediction and the difference_angle index for notifying a curvature of the curved intra prediction are encoded and transmitted.

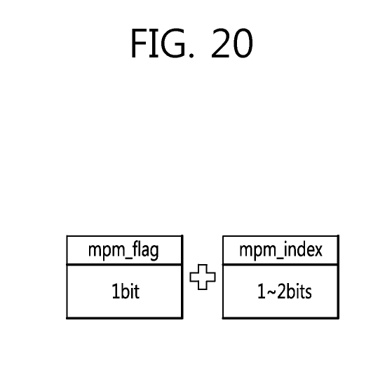

When the prediction mode is encoded, it needs to be distinguished whether base_intra_prediction_mode coincides with one of MPMs or not. Then, it may be distinguished whether the linear intra prediction is used or the curved intra prediction is used. In the case of occurrence, forms of indexes to be encoded may be described in FIGS. 20 to 25 given below.

When base_intra_prediction_mode of the current block is the same as mpm and is the DC or planar mode, base_intra_prediction_mode of the current block is encoded as illustrated in FIG. 20.

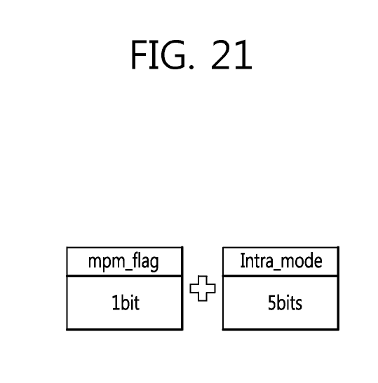

When base_intra_prediction_mode of the current block is not the same as mpm and is encoded in the DC or planar mode, base_intra_prediction_mod of the current block is encoded as illustrated in FIG. 21.

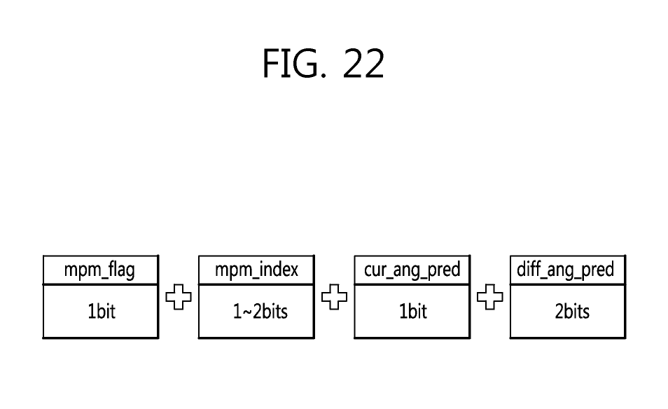

When base_intra_prediction_mode of the current block is the same as mpm and is encoded by the curved intra prediction, base_intra_prediction_mod of the current block is encoded as illustrated in FIG. 22.

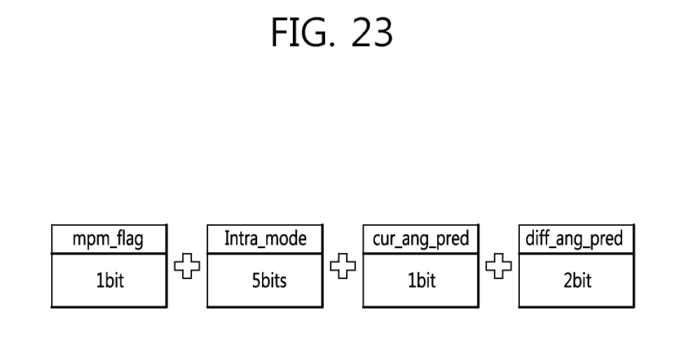

When base_intra_prediction_mode of the current block is not the same as mpm and is encoded by the curved intra prediction, base_intra_prediction_mod of the current block is encoded as illustrated in FIG. 23.

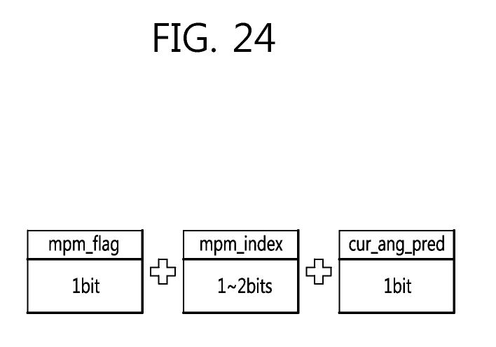

When base_intra_prediction_mode of the current block is the same as mpm and is not encoded by the curved intra prediction, base_intra_prediction_mod of the current block is encoded as illustrated in FIG. 24.

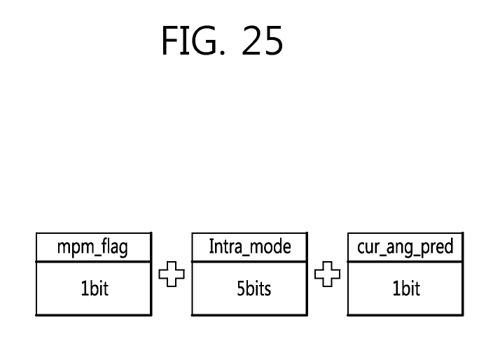

When base_intra_prediction_mode of the current block is not the same as mpm and is not encoded by the curved intra prediction, base_intra_prediction_mod of the current block is encoded as illustrated in FIG. 25.

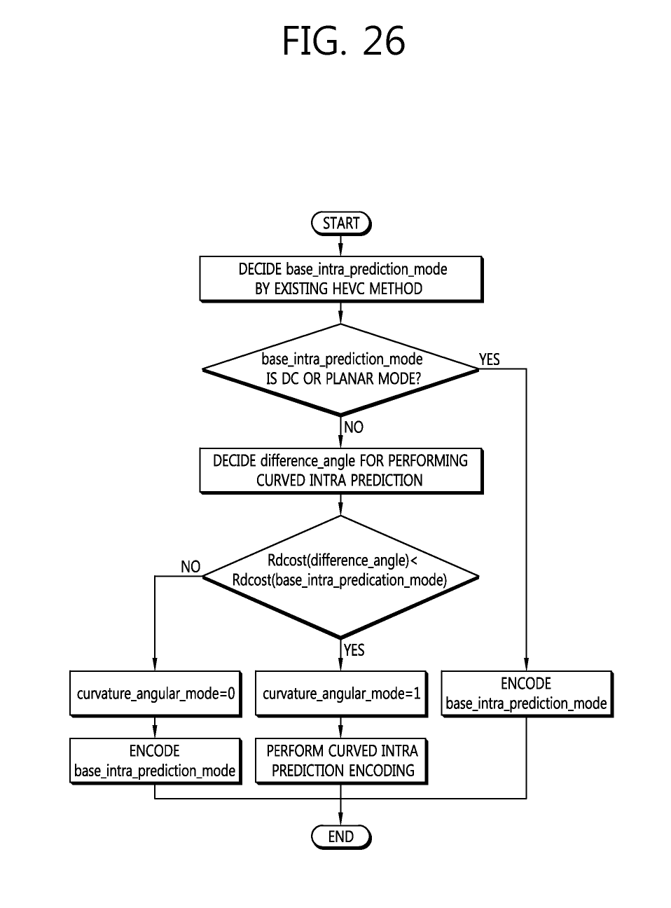

FIG. 26 illustrates a flowchart of a method for performing a curved intra prediction according to an embodiment of the present invention stepwise.

Implicit Curved Intra Prediction

In the embodiment of the present invention, in order to perform the curved intra prediction, (1) a process of deciding base_intra_prediction_mode and (2) a process of calculating difference_intra_prediction_mode, and (3) a process of deciding line_intra_prediction_mode for each prediction line may be executed.

In this case, the line may be a set of pixels that are present on the same horizontal line or a set of pixels that are present on the same vertical column. Alternatively, the line may be a set of pixels having the same angle in the diagonal direction.

First, the base prediction direction (base_intra_prediction_mode) to intra-predict the current prediction block is decided and thereafter, reference_intra_prediction_mode of contiguous pixels is decided by using contiguous pixel values. Then, <difference_intra_prediction_mode=base_intra_prediction_mode−reference_intra_prediction_mode> is calculated. The prediction direction mode (line_intra_prediction_mode) adjusted for each line is decided by using difference_intra_prediction_mode.

(1) Deciding base_intra_prediction_mode

This step is a step of deciding the base prediction direction used when performing the curved intra prediction of the current prediction block. The base prediction direction mode (base_intra_prediction_mode) is decided by using the intra prediction mode deciding method performed in the exiting HEVC. That is, when the current encoding block is intra-predicted by using contiguous pixel values of the current encoding block, the existing HEVC intra predicting method considering a total of 35 prediction modes is used. As such, base_intra_prediction_mode is decided by the existing intra prediction method of the HEVC and thereafter, in next step, the curved intra prediction similar thereto is performed.

As described above, FIG. 5 illustrates an example in which the vertical prediction mode is decided through the intra prediction method used in the HEVC. In this example, in order to encode the current prediction block, 35 prediction modes used by the HEVC are considered and finally, it is described that the vertical prediction mode is selected as an example. The vertical mode decided in this example may be called base_intra_prediction_mode in the present invention.

(2) Deciding difference_intra_prediction_mode

In this step, how to compensate the intra prediction direction in the current prediction block by using pixel information of the first encoded and decoded blocks is decided.

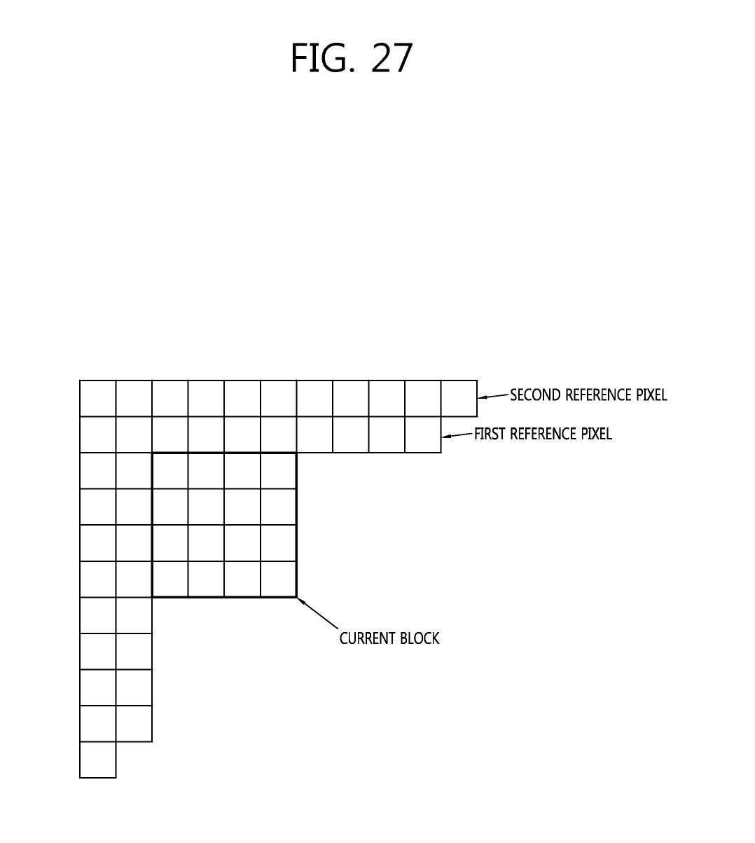

FIG. 27 illustrates a first reference pixel and a second reference pixel for calculating difference_intra_prediction_mode.

In FIG. 27, the contiguous pixels of the current encoding block are expressed as the first reference pixels and the second reference pixels. The first reference pixels are contiguous pixels most adjacent to the current encoding block and the second reference pixels are contiguous pixels more distant positioned than the first reference pixels.

In this step, the existing HEVC intra prediction method is applied to the second reference pixels to predict the first reference pixels. In this case, all of 35 modes used in the HEVC intra mode are considered. During this process, a direction mode having a smallest sum of absolute difference (SAD) between original values of the first reference pixels and the predicted first reference pixels is decided as reference_intra_prediction_mode.

A difference value between reference_intra_prediction_mode and base_intra_prediction_mode decided in the previous step may be decided by using <difference_intra_prediction_mode=base_intra_prediction_mode−reference_intra_prediction_mode>.

In this case, when base_intra_prediction_mode or reference_intra_prediction_mode is the planar or DC mode, difference_intra_prediction_mode is not calculated.

In addition, when an absolute value of difference_intra_prediction_mode is smaller than 3, the next step is executed in order to perform the curved intra prediction. However, when the absolute value of difference_intra_prediction_mode is equal to or larger than 3, a difference between a feature of the current prediction block and features of the contiguous blocks is large, and as a result, the existing HEVC intra prediction technology is used by using not the curved intra prediction but base_intra_prediction_mode.

(3) Deciding line_intra_prediction_mode

Herein, the case in which base_intra_prediction_mode is the vertical mode will be described as an example. In this case, since base_intra_prediction_mode is the vertical mode, the line becomes a set of pixels at the same horizontal position. In this case, the intra prediction encoding is performed by slightly adjusting each line based on base_intra_prediction_mode.

FIG. 6 described above illustrates the prediction mode of the first line in the prediction block.

FIG. 6 is a diagram illustrating the prediction angle of the first line in the 4×4 PU. line_intra_prediction_mode(1) of the first line becomes the mode which is the same as base_intra_prediction_mode.

From the second line, a mode acquired by adding difference_intra_prediction_mode to which is the vertical mode as base_intra_prediction_mode is used as line_intra_prediction_mode(2) of the second line.

line_intra_prediction_mode(2)=base_intra_prediction_mode+difference_intra_prediction_mode

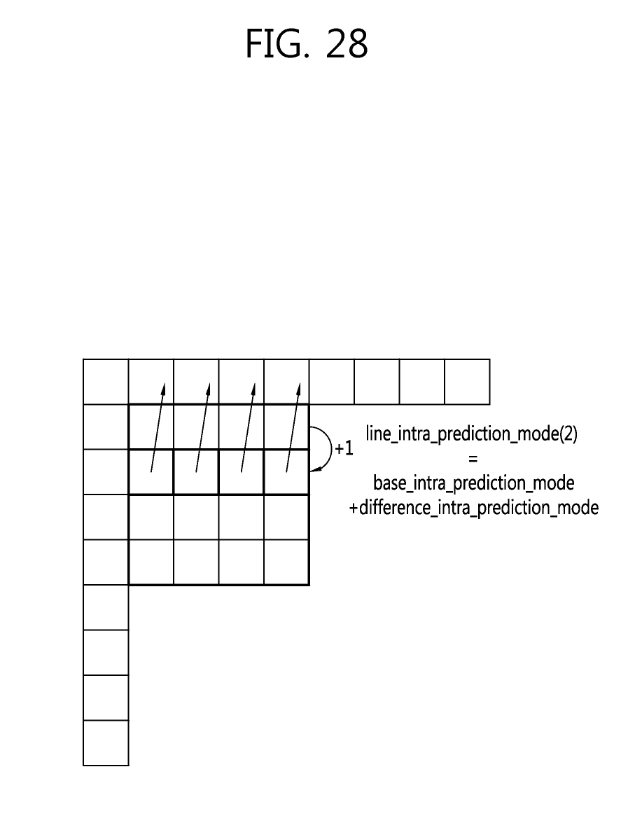

FIG. 28 illustrates the prediction mode of the second line in the prediction block. In FIG. 28, the case in which difference_intra_prediction_mode=1 is schematically described.

As the line gradually decreases, the difference between base_intra_prediction_mode and line_intra_prediction_mode gradually increases. The next figure shows the prediction modes on the third and fourth lines. In addition, the respective prediction modes on the third and fourth lines are described below.

line_intra_prediction_mode(3)=base_intra_prediction_mode+2*difference_intra_prediction_mode

line_intra_prediction_mode(4)=base_intra_prediction_mode+3*difference_intra_prediction_mode

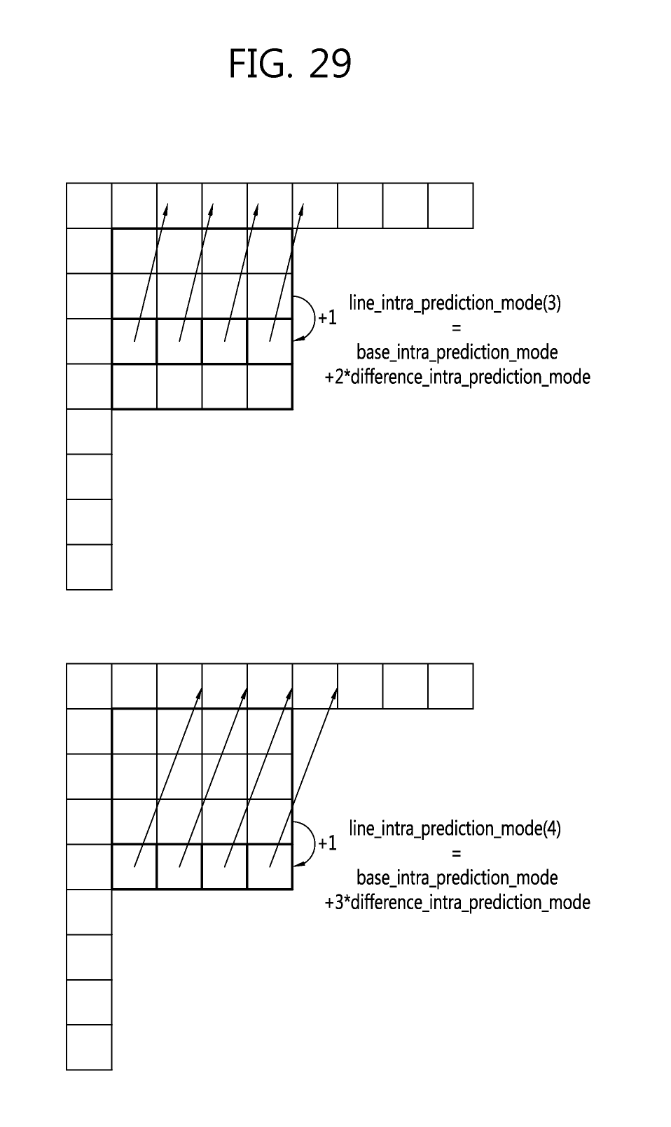

FIG. 29 illustrates prediction angles of a third line and a fourth line in a prediction block according to another embodiment of the present invention. In FIG. 29, intra prediction modes on the third and fourth lines when difference_intra_prediction_mode=1 are described.

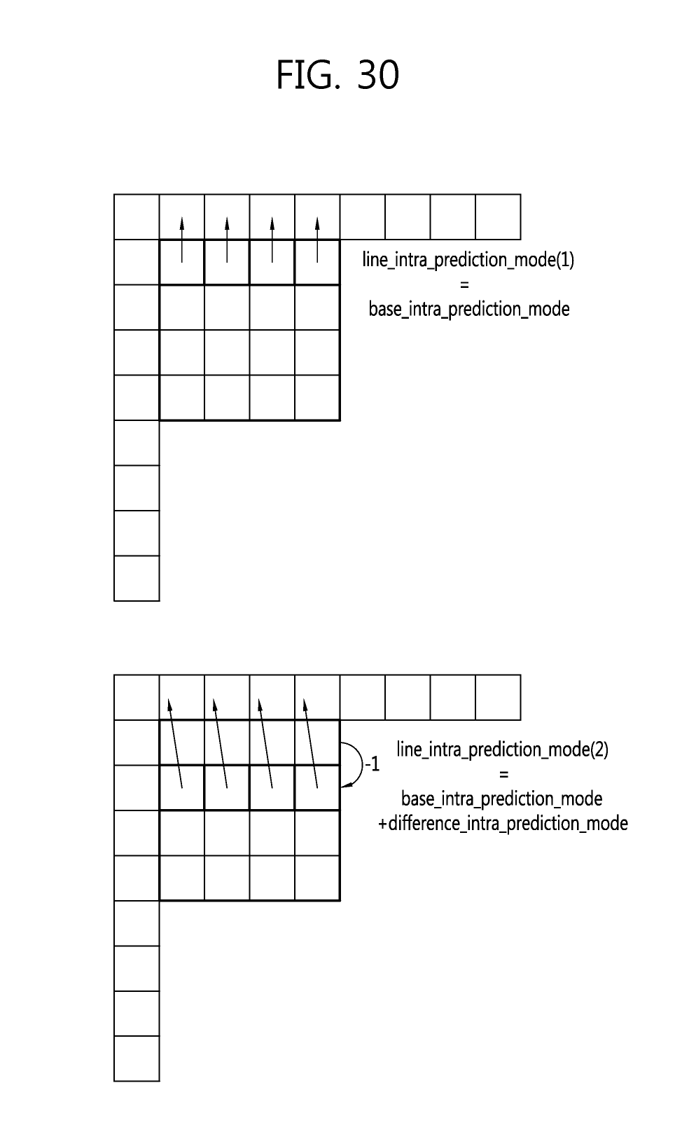

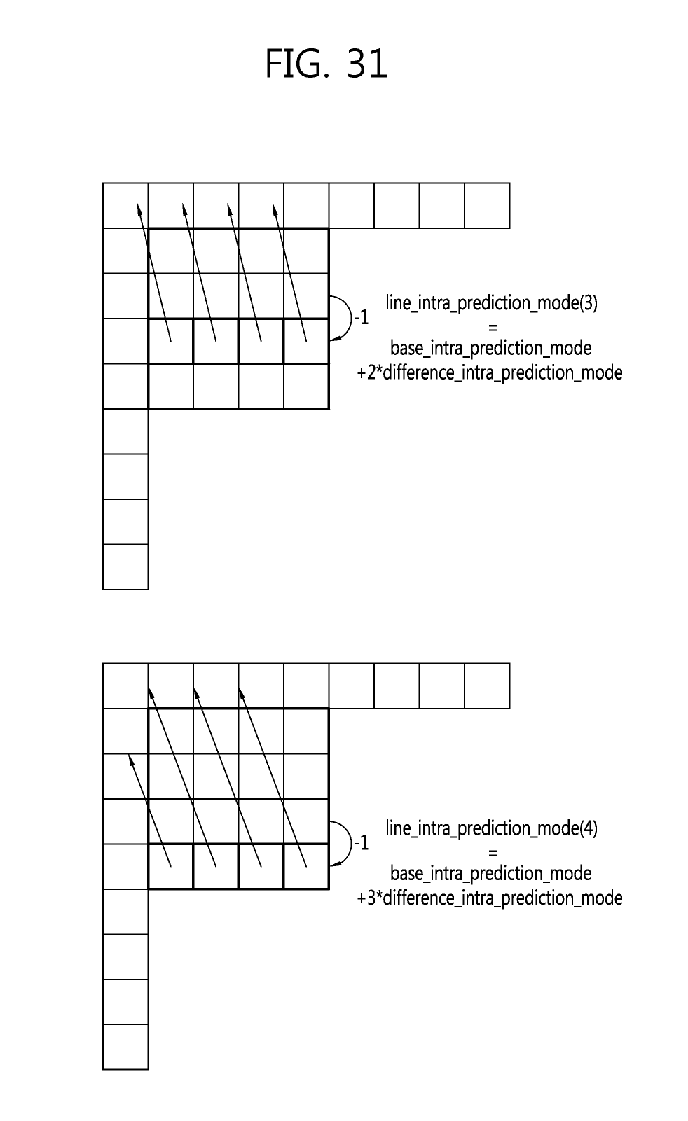

FIGS. 30 and 31 illustrate a case in which difference_intra_prediction_mode=−1.

FIGS. 30 and 31 are diagrams for describing prediction modes for four respective lines base_intra_prediction_mode=vertical and difference_intra_prediction_mode=−1. FIG. 30 illustrates the prediction angles of the first and second lines when difference_intra_prediction_mode is −1 and FIG. 31 illustrates the prediction angles of the third and fourth lines when difference_intra_prediction_mode is −1.

The angle of 135° when base_intra_prediction_mode is mode #18 is similar to that described above and alternation points are described below.

The pixels P(1,0), P(0,1), and P(1,1) that belong to the second line is predicted by base_intra_prediction_mode+difference_intra_prediction_mode.

Pixels P(2,0), P(2,1), P(2,2), P(0,2), and P(1,2) that belong to the third line is predicted by base_intra_prediction_mode+2*difference_intra_prediction_mode.

Pixels P(3,0), P(3,1), P(3,2), P(3,3), P(0,3), P(1,3), and P(2,3) that belong to the fourth line is predicted by base_intra_prediction_mode+3*difference_intra_prediction_mode.

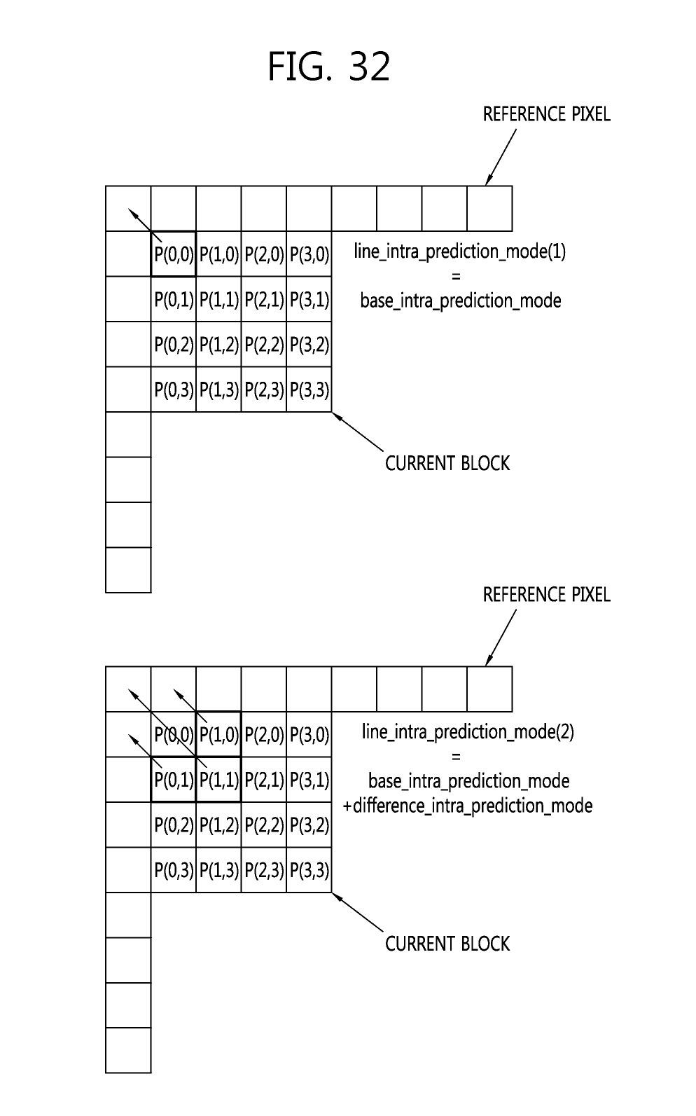

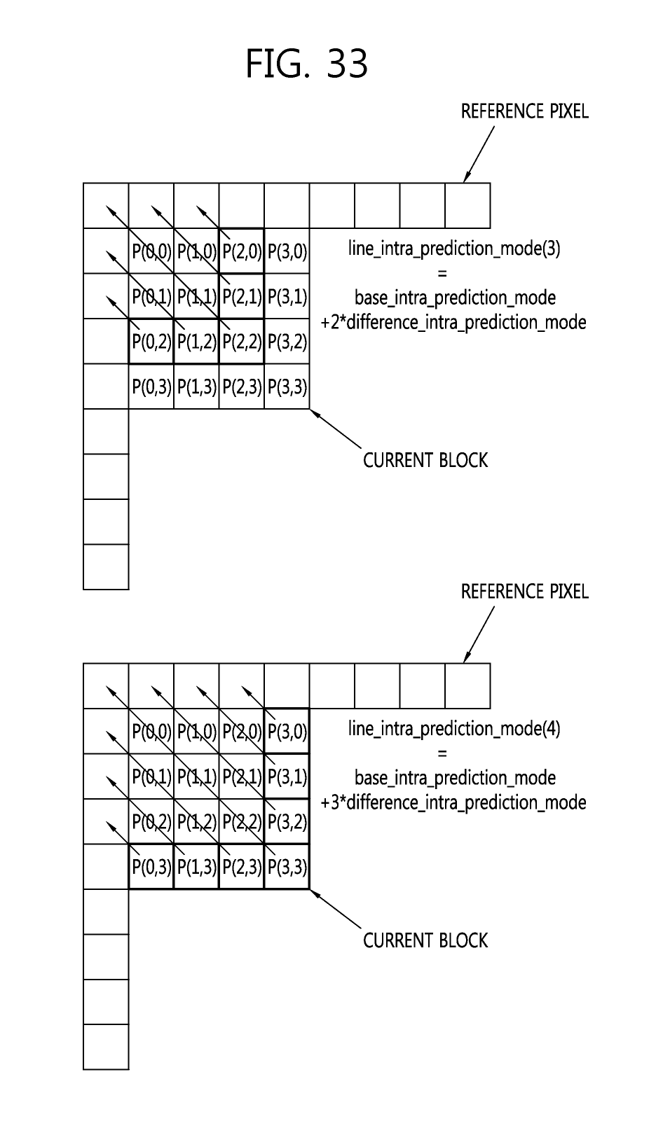

FIGS. 32 and 33 illustrate the case in which difference_intra_prediction_mode=−1. FIG. 32 illustrates the position of the pixel predicted by base_intra_prediction_mode and the position of the pixel predicted by difference_intra_prediction_mode and FIG. 33 illustrates the position of the pixel predicted by 2*difference_intra_prediction_mode and the position of the pixel predicted by 3*difference_intra_prediction_mode.

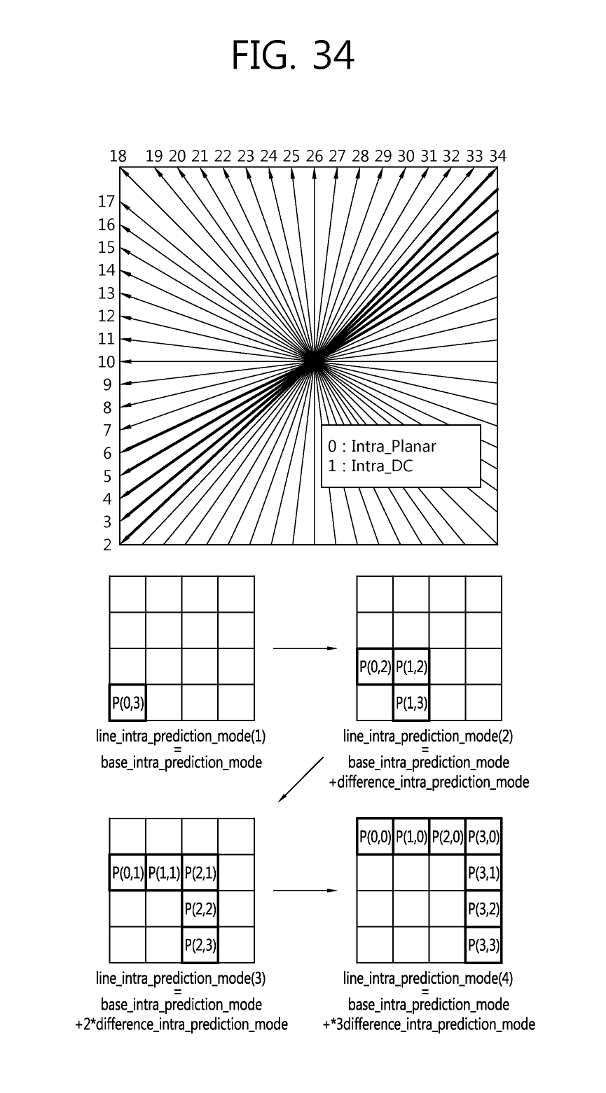

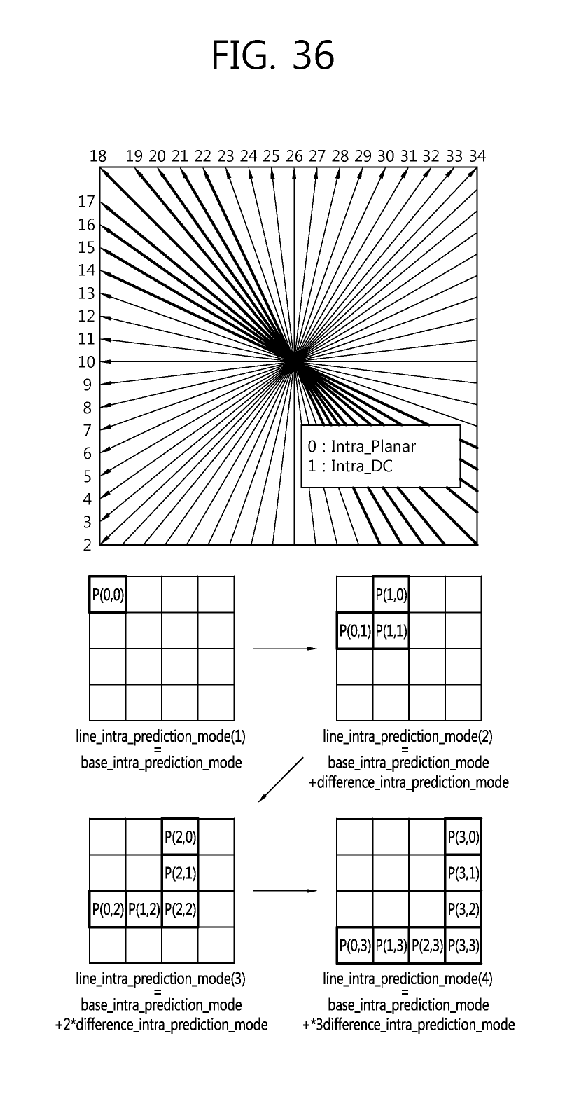

FIG. 34 illustrates a prediction pixel position adopting difference_intra_prediction_mode when base_intra_mode<7. FIG. 36 illustrates shapes of lines differentially using difference_angle when base_intra_prediction_mode is smaller than mode #7.

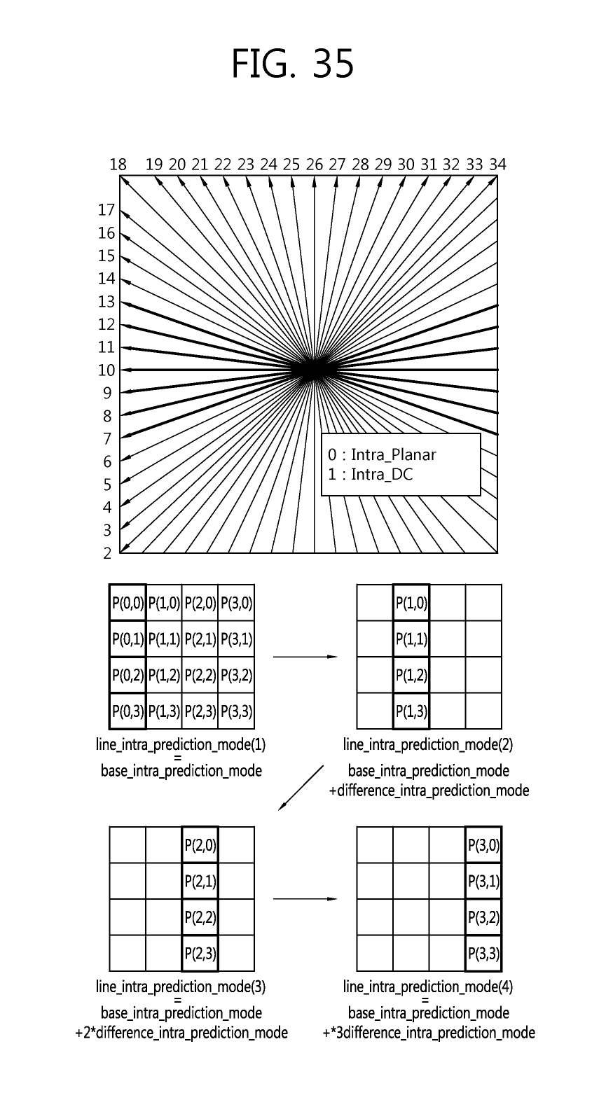

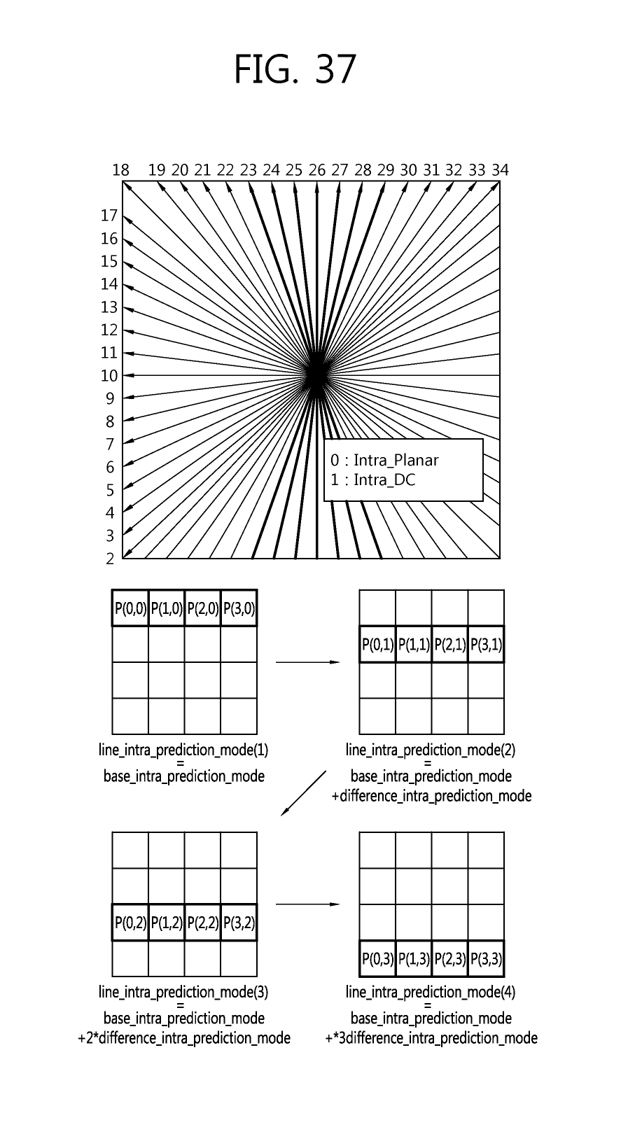

FIG. 35 illustrates the prediction pixel position adopting difference_intra_prediction_mode when 7<=base_intra_mode<14. FIG. 37 is a diagram describing a shape of a line to which difference_angle is differentially applied when base_intra_prediction_mode is equal to or larger than 7 or smaller than #14.

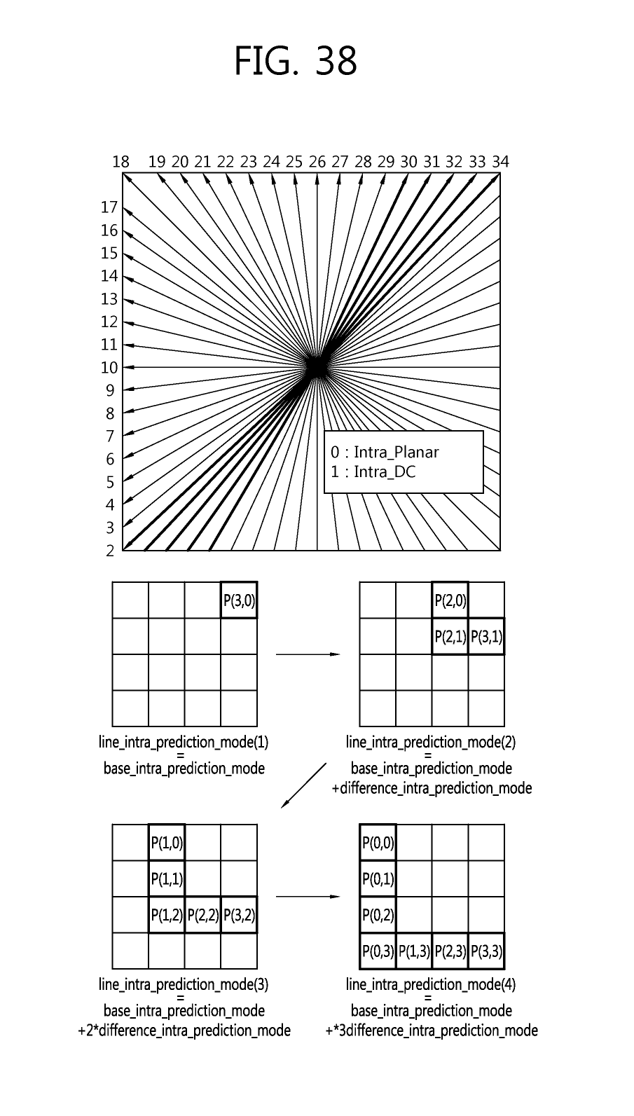

FIG. 36 illustrates the prediction pixel position adopting difference_angle when 14<=base_intra_mode<23. FIG. 38 illustrates a concept of the line to which differential difference_angle is applied when base_intra_prediction_mode is 14<=base_intra_prediction_mode<23.

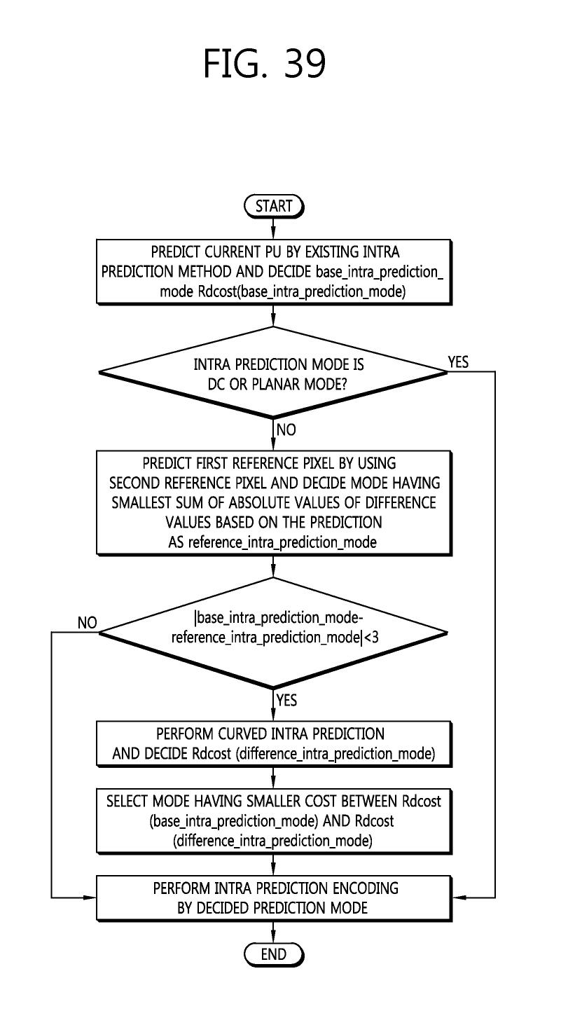

FIG. 37 illustrates the prediction pixel position adopting difference_intra_prediction_mode when 23<=base_intra_mode<30. FIG. 39 is a diagram showing positions (line shape) of prediction pixels to which difference_angle is differentially applied when 23<=base_intra_prediction_mode<30.

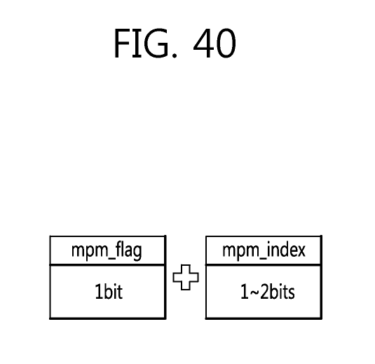

FIG. 38 illustrates the prediction pixel position adopting difference_intra_prediction_mode when 30<=base_intra_mode<35. FIG. 40 is a diagram showing positions (line shape) of prediction pixels to which difference_angle is differentially applied when 30<=base_intra_prediction_mode<35.

<Flowchart During Intra Prediction Process>

FIG. 39 illustrates a flowchart of a curved intra prediction. When the absolute value of difference_intra_prediction_mode which is the difference between base_intra_prediction_mode and reference_intra_prediction_mode described above is smaller than 3, the curved intra prediction encoding is performed. When the absolute value of difference_intra_prediction_mode is equal to or larger than 3, the intra prediction is performed by using base_intra_prediction_mode.

When the curved intra prediction is performed, differential intra prediction modes are used for each line in the prediction block. The detailed modes are described below.

Prediction mode of first line:

line_intra_prediction_mode(1)=base_intra_prediction_mode

Prediction mode of second line:

line_intra_prediction_mode=base_intra_prediction_mode(2)+difference_intra_prediction_mode

Prediction mode of third line:

line_intra_prediction_mode=base_intra_prediction_mode(3)+2*difference_intra_prediction_mode

Prediction mode of fourth line:

line_intra_prediction_mode=base_intra_prediction_mode(4)+3*difference_intra_prediction_mode

In a last step of the intra prediction encoding, RC cost when the proposed curved intra prediction is used and the RD cost when the existing intra prediction method (the method using base_intra_prediction) used in the HEVC is used are compared and thereafter, a mode and a method having the smaller RC cost value are used.

<Syntax Structure Considering Transmission Flag>

When the finally decided optimal mode becomes the curved intra prediction mode while |difference_intra_prediction_model<3, curvature_angular_pred becomes 1. Otherwise, when the finally decided optimal mode is the existing mode of the HEVC, curvature_angular_pred is transmitted as 0.

Since the curved intra prediction mode is not considered when |difference_intra_model<3 is not satisfied, curvature_angular_pred flag is not transmitted.

The case of encoding the curved intra prediction mode is described in two. In a first case, MPM and base_intra_prediction_mode of the current block are the same as each other. In this case, MPM flag of 1 bit, MPM index of 1 to 2 bits, and curvature_angular_pred of 1 bit are transmitted. In a second case, MPM and base_intra_prediction_mode of the current block are different from each other. In this case, MPM flag of 1 bit, base_intra_prediction_mode of 5 bits, and curvature_angular_pred of 1 bit are transmitted. A syntax of the present invention proposed to assist understanding the described contents for each case will be described with reference to FIGS. 40 to 45.

When base_intra_prediction_mode of the current block is the same as mpm and is encoded in the DC or planar mode, base_intra_prediction_mode of the current block is illustrated in FIG. 40.

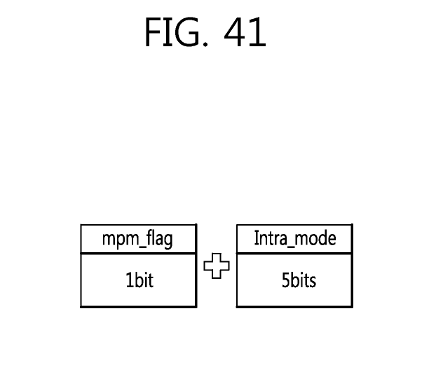

When base_intra_prediction_mode of the current block is not the same as mpm and is encoded the DC or planar mode, base_intra_prediction_mode of the current block is illustrated in FIG. 41.

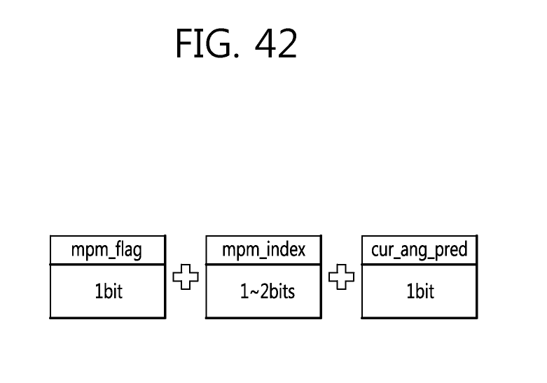

When base_intra_prediction_mode of the current block is the same as mpm and is encoded by the curved intra prediction, base_intra_prediction_mode of the current block is illustrated in FIG. 42.

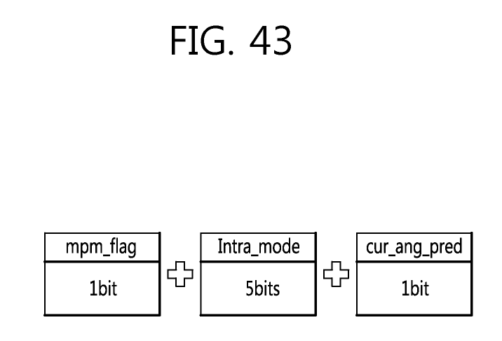

When base_intra_prediction_mode of the current block is not the same as mpm and is encoded by the curved intra prediction, base_intra_prediction_mode of the current block is illustrated in FIG. 43.

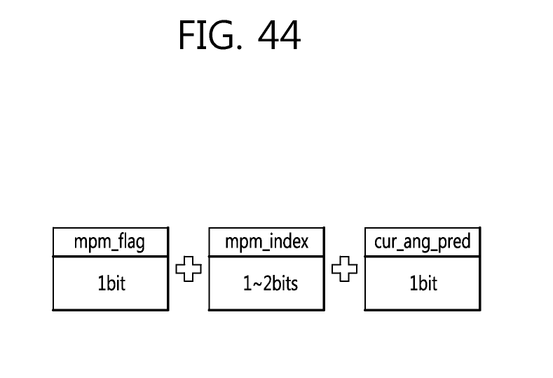

When base_intra_prediction_mode of the current block is the same as mpm and is not encoded by the curved intra prediction, base_intra_prediction_mode of the current block is illustrated in FIG. 44.

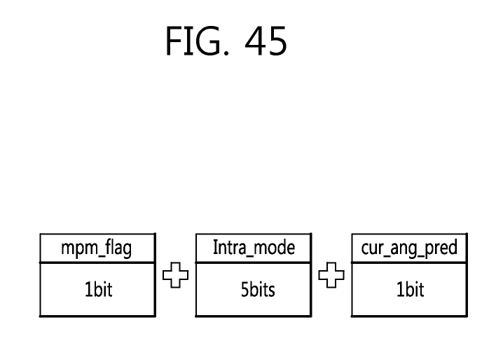

When base_intra_prediction_mode of the current block is not the same as mpm and is not encoded by the curved intra prediction, base_intra_prediction_mod of the current block is illustrated in FIG. 45.

<Flowchart During Decoding Process>

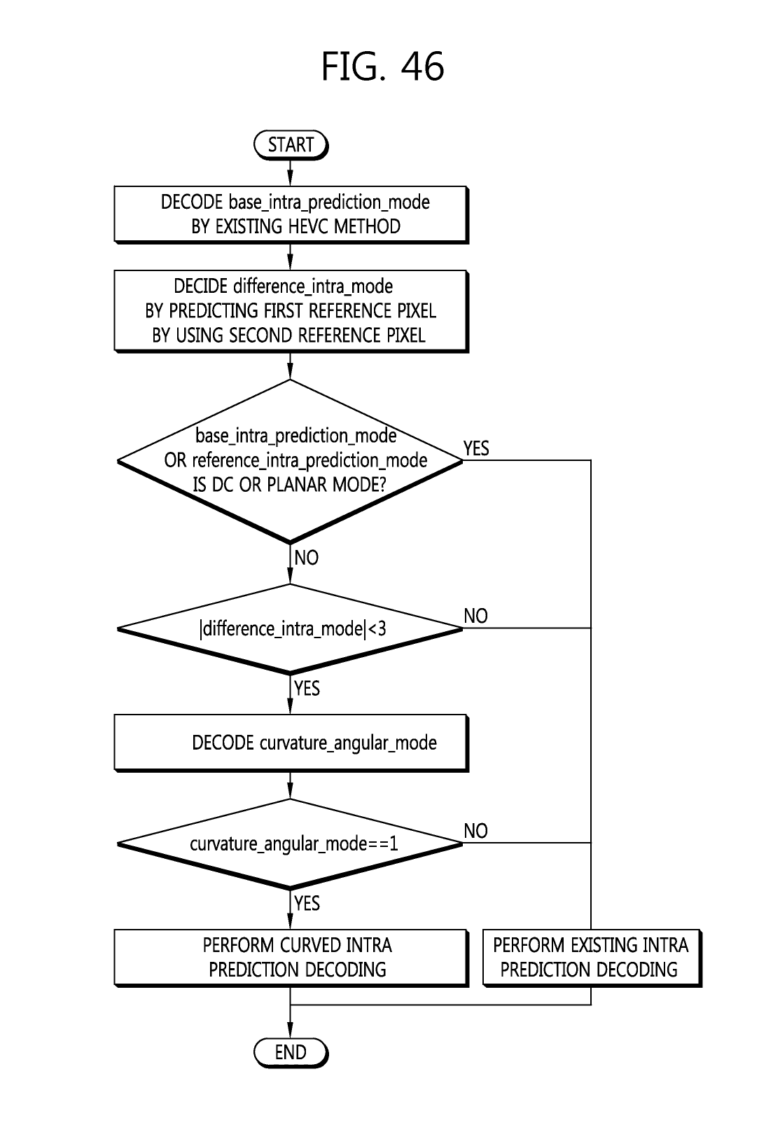

FIG. 46 illustrates a flowchart of decoding the curved intra prediction.

In a first process of the decoding, base_intra_prediction_mode is decoded for each block. Thereafter, the existing HEVC intra prediction method is applied to the second reference pixels to predict the first reference pixels. In this case, all of 35 modes used in the HEVC intra mode are used. During this process, the direction mode having the smallest sum of absolute difference (SAD) between the original values of the first reference pixels and the predicted first reference pixels is decided as reference_intra_prediction_mode. Thereafter, when base_intra_prediction_mode or reference_intra_prediction_mode is the DC or planar mode, base_intra_prediction_mode or reference_intra_prediction_mode is decoded by the existing method of the HEVC.

A difference value between reference_intra_prediction_mode and base_intra_prediction_mode decided in the previous step is decided as shown in an equation given below.

difference_intra_prediction_mode=base_intra_prediction_mode−reference_intra_prediction_mode

When base_intra_prediction_mode or reference_intra_prediction_mode is the DC or planar mode and the absolute value of difference_intra_prediction_mode is smaller than 3, curvature_angular_pred flag is decoded and when curvature_angular_pred flag is 1, base_intra_prediction_mode or reference_intra_prediction_mode is decoded by the curved intra decoding method and when curvature_angular_pred flag is 0, base_intra_prediction_mode or reference_intra_prediction_mode is decoded by the existing method of the HEVC. Herein, since difference_intra_prediction_mode may be calculated by using the contiguous reference pixels in the encoder and the decoder, difference_intra_prediction_mode may be encoded/decoded without separate transmission.

As described above, when the technology of the present invention is used, compression efficiency may be improved by performing the linear intra prediction and the curved intra prediction.

The method according to the present invention is prepared as a program to be executed in a computer to be stored in a computer-readable recording medium and an example of the computer readable medium may include a read only memory (ROM), a random access memory (RAM), a compact disk read only memory (CD-ROM), a magnetic tape, a floppy disk, an optical data storage, or the like, and also include a medium implemented in a form of a carrier wave (for example, transmission through the Internet).

The computer-readable recording media are distributed on computer systems connected through the network, and thus the computer-readable recording media may be stored and executed as the computer-readable code by a distribution scheme. Further, functional programs, codes, and code segments for implementing the method may be easily inferred by a programmer in a technical field to which the present invention belongs.

While the exemplary embodiments of the present invention have been illustrated and described above, the present invention is not limited to the aforementioned specific exemplary embodiments, various modifications may be made by a person with ordinary skill in the technical field to which the present invention pertains without departing from the subject matters of the present invention that are claimed in the claims, and these modifications should not be appreciated individually from the technical spirit or prospect of the present invention.

What is claimed is:

1. A video encoding method comprising:
determining an encoding mode for a video block;
determining whether to perform a curved prediction mode when the encoding mode is an intra prediction; and
performing intra encoding according to the determination on whether to perform the curved prediction and a base intra prediction mode.

2. The video encoding method of claim 1, wherein the determining whether to perform the curved prediction includes deciding a base prediction direction and deciding a reference intra mode of contiguous pixels.

3. The video encoding method of claim 2, further comprising:
deciding a difference value between the reference intra mode and the base prediction direction.

4. The video encoding method of claim 3, further comprising:
deciding a prediction direction mode adjusted for each line based on the difference value.

5. A video encoding apparatus comprising:
a mode determining unit determining an encoding mode for a video block;
a curved prediction mode determining unit determining whether to perform a curved prediction mode when the encoding mode is an intra prediction; and
an encoding unit performing intra encoding according to the determination on whether to perform the curved prediction and a base intra prediction mode.

6. The video encoding apparatus of claim 5, wherein the curved prediction mode determining unit decides a base prediction direction and decides a reference intra mode of contiguous pixels.

7. The video encoding apparatus of claim 6, wherein the curved prediction mode determining unit decides a difference value between the reference intra mode and the base prediction direction.

8. The video encoding apparatus of claim 7, wherein the curved prediction mode determining unit decides a prediction direction mode adjusted for each line based on the difference value.

9. The video encoding apparatus of claim 5, wherein the curved prediction mode determining unit performs a curved intra prediction when an absolute value of an intra prediction mode difference value of contiguous blocks is smaller than a predetermined value.

10. A video encoding method comprising:
determining an encoding mode for a video block;
determining whether to perform a curved prediction mode when the encoding mode is an intra prediction; and
performing intra encoding according to an intra curvature difference angle when the curved prediction mode is performed.

11. The video encoding method of claim 10, wherein the difference angle are limited to multiple values based on a base intra prediction mode.

12. The video encoding method of claim 11, wherein the multiple values include at least one of −2, −1, 1, and 2.

13. A video encoding apparatus comprising:
a mode determining unit determining an encoding mode for a video block;
a curved prediction mode determining unit determining whether to perform a curved prediction mode when the encoding mode is an intra prediction; and
an intra encoding unit performing intra encoding according to an intra curvature difference angle when the curved prediction is performed.

14. The video encoding apparatus of claim 13, wherein the difference angle are limited to multiple values based on a base intra prediction mode.

15. The video encoding apparatus of claim 14, wherein
the multiple values include at least one of −2, −1, 1, and 2.
